(19) United States
(12) Patent Application Publication
(10) Pub. No.: US 2019/0248480 A1
(43) Pub. Date: Aug. 15, 2019

(54) MODULAR UNMANNED AERIAL VEHICLE WITH ADJUSTABLE CENTER OF GRAVITY

(71) Applicant: Advanced Aerial Services, LLC, Woodward, OK (US)

(72) Inventor: Donald Lee Whitten, Jr., Woodward, OK (US)

(21) Appl. No.: 16/345,838

(22) PCT Filed: Oct. 30, 2017
(86) PCT No.: PCT/US17/59085

§ 371 Date: Apr. 29, 2019

Related U.S. Application Data
(60) Provisional application No. 62/414,911, filed on Oct. 31, 2016.

(51) Int. Cl. B64C 27/28; B64C 39/02

(52) U.S. Cl. CPC B64C 27/28; B64C 39/024; B64C 2201/086; B64C 2201/024; B64C 2201/104; B64C 2201/027; B64C 2201/108

(57) ABSTRACT

An aerial vehicle system including a vertical takeoff and landing apparatus, a wing assembly removably coupled to the vertical takeoff and landing apparatus, and a rotor guard interchangeable with the wing assembly and removably coupleable to the vertical takeoff and landing apparatus. The vertical takeoff and landing apparatus can include a frame, a control module carried by the frame, and a plurality of thrust assemblies carried by the frame.

### CROSS-REFERENCE TO RELATED APPLICATION

This application claims the benefit of and priority to U.S. Patent Application No. 62/414,911, filed Oct. 31, 2016, the disclosure of which is incorporated herein by reference in its entirety.

### TECHNICAL FIELD

The present technology is directed to aerial vehicles and, more specifically, to vertical takeoff and landing (VTOL) unmanned aerial vehicles having a modular airfoil assembly and propeller guard, an independent, separable, fully functional lift and thrust producing mechanism, and an adjustable center of gravity.

### BACKGROUND

Unmanned aerial vehicles (UAVs) are becoming more common, with many designs having flight capabilities of a helicopter or multi-copter that provides for VTOL and hovering capabilities, but with inefficient horizontal flight capability. In some cases, UAVs are configured as fixed wing aircraft, permitting efficient horizontal flight, but with relatively poor payload carrying capacity and an inability to fly vertically or hover.

### BRIEF DESCRIPTION OF THE DRAWINGS

Modular UAVs with adjustable center of gravity described herein may be better understood by referring to the following Detailed Description in conjunction with the accompanying drawings, in which like reference numerals indicate identical or functionally similar elements:

FIG. 1 is an isometric view of an UAV with adjustable center of gravity according to a representative embodiment shown configured for VTOL;

FIG. 2 is an isometric view of the UAV shown in FIG. 1 configured for horizontal flight;

FIG. 3 is an isometric view of the UAV shown in FIGS. 1 and 2 as viewed from in front of and below the UAV;

FIG. 4 is an isometric view of the UAV shown in FIGS. 1-3 as viewed from behind and below the UAV;

FIG. 5 is a top plan view of the UAV shown in FIGS. 1-4;

FIG. 6 is an isometric view of the wing assembly;

FIG. 7A is a top plan view of the UAV;

FIG. 7B is a front view in elevation of the UAV shown in FIG. 7A;

FIG. 7C is a side view in elevation of the UAV shown in FIGS. 7A and 7B;

FIG. 8A is an isometric view of a portion of the wing assembly;

FIG. 8B is an exploded isometric view of a portion of the wing assembly;

FIG. 9 is an isometric view of a portion of the forward wing;

FIG. 10 is an exploded isometric view of the wing spar connection to the airframe;

FIG. 11 is an isometric view of the rotor assembly positioning mechanism;

FIG. 12 is an isometric view of an alternative configuration of the multi-copter assembly;

FIG. 13 is an isometric view of another configuration for the multi-copter assembly;

FIG. 14 is an isometric view of the multi-copter assembly shown in FIG. 13 with alternative landing gear attachments;

FIG. 15 is an isometric view of a UAV, in accordance with a representative embodiment;

FIG. 16 is a front view in elevation of a UAV, in accordance with a representative embodiment;

FIG. 17 is a back view in elevation of a UAV, in accordance with a representative embodiment;

FIG. 18 is a top plan view of a UAV, in accordance with a representative embodiment;

FIG. 19 is a bottom plan view of a UAV, in accordance with a representative embodiment;

FIG. 20 is a left view in elevation of a UAV, in accordance with a representative embodiment;

FIG. 21 is a right view in elevation of a UAV, in accordance with a representative embodiment;

FIG. 22 is an isometric view of a modular propulsion system in the form of a multi-copter, in accordance with a representative embodiment;

FIG. 23 is an isometric view of a modular propulsion system in the form of a multi-copter with the addition of a propeller guard, in accordance with a representative embodiment;

FIG. 24 is an isometric view of a modular wing airfoil assembly, in accordance with a representative embodiment;

FIG. 25 is an isometric view of a forewing to airframe attachment assembly, in accordance with a representative embodiment;

FIG. 26 is an exploded isometric view of a forewing to airframe attachment assembly, in accordance with a representative embodiment;

FIG. 27A is an isometric view of a forewing to airframe attachment assembly connected to a forewing, in accordance with a representative embodiment;

FIG. 27B is an isometric view of the forewing shown in a folded configuration;

FIG. 28 is an isometric view of an aft wing to airframe attachment assembly, in accordance with a representative embodiment;

FIG. 29 is an exploded isometric view of an aft wing to airframe attachment assembly, in accordance with a representative embodiment;

FIG. 30 is an isometric view of an aft wing to airframe attachment assembly connected to an aft wing, in accordance with a representative embodiment;

FIG. 31 is an isometric view of an airframe with a control module attached, in accordance with a representative embodiment

FIG. 32 is top plan view of an airframe and thruster shaft rotator assembly, in accordance with a representative embodiment;

FIG. 33 is an exploded isometric view of an airframe and thruster shaft rotator assembly, in accordance with a representative embodiment;

FIG. 34 is an isometric view of a thruster shaft rotator servo assembly, in accordance with a representative embodiment;

FIG. 35 is an exploded isometric view of a thruster shaft rotator servo assembly, in accordance with a representative embodiment;

FIG. 36 is a top plan view of a propeller guard assembly, in accordance with a representative embodiment;

FIG. 37 is an exploded isometric view of a propeller guard assembly, in accordance with a representative embodiment;

FIG. 38 is a top plan view of an airframe's center of gravity adjusted by use of a modular wing airfoil assembly, to a point 15 mm forward of design center of gravity, in accordance with a representative embodiment;

FIG. 39 is a top plan view of an airframe's center of gravity adjusted by use of a modular propeller guard assembly, to a point 15 mm aft of design center of gravity, in accordance with a representative embodiment;

FIG. 40 is an isometric view of a wingtip connector assembly, in accordance with a representative embodiment;

FIG. 41 is an isometric view of an alternate wingtip connector assembly; and

FIG. 42 is an exploded isometric view of an alternate wingtip connector assembly.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover suitable modifications, combinations, equivalents, and/or alternatives falling within the scope of this disclosure.

### DETAILED DESCRIPTION

### Overview

Disclosed herein are UAVs comprising modular components providing various capabilities including vertical takeoff and landing, hovering, efficient horizontal flight and operations on the surface of water, for example.

This disclosure describes reconfigurable UAVs with interchangeable modular components that can be used to selectively reconfigure the UAV to modify its flight characteristics and operational and payload carrying capabilities. In some embodiments, the UAV can include a multi-copter airframe having, any suitable number of motor-propeller systems (rotors) to provide the capability of VTOL, hovering and horizontal flight. For example, the UAV may have one or more lifting rotors whose thrust is directed substantially downward and whose lift is directed substantially upward to permit flight capabilities similar to that of a helicopter, multi-copter or similar aircraft.

In some embodiments, the UAV can include a wing assembly having one or more modular wings removably coupled to the airframe so as to permit flight capabilities similar to that of a fixed wing aircraft. For example, when the UAV is configured to perform as a fixed wing aircraft for predominantly horizontal flight, it also has the capability of VTOL and hovering by way of one or more of the rotors which may be rotated to a position of more or less than 90 degrees to the downward thrust direction, and then engaged, and the thus rotated and engaged rotor/s may provide thrust in an essentially horizontal direction to push and/or pull the UAV essentially horizontally through the air.

In some embodiments, the UAV can further comprise one or more modular flotation, water surface and flight operations components and control systems which may be installed onto the component systems of the airframe in singularity or in conjunction with the wing assembly, providing the capabilities of VTOL, hovering and efficient, horizontal flight along with the capabilities of water surface operations such as that of an amphibious aircraft, for example.

### General Description

Various examples of the devices introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures and/or functions may not be shown or described in detail below so as to avoid unnecessarily obscuring the relevant description.

Many UAV designs are similar in form and function to that of a helicopter or multi-copter (rotorcraft), providing vertical takeoff and landing (VTOL) and hovering, but demonstrating inefficient horizontal flight. Other UAVs mimic the designs of common fixed-wing aircraft, offering more efficient horizontal flight but no ability to take off and land vertically or to hover. Other UAVs are hybrids consisting of fixed wings with VTOL components (VTOL fixed wing). There are situations and circumstances where a rotorcraft is best suited, such as inspecting or photographing the underside of a bridge, the interior of a tunnel, or the face of a dam, as examples. And, there are situations and circumstances best suited to the use of a fixed wing or VTOL fixed wing, such as large area mapping and surveying, precision agriculture, and long-distance or long-duration flights, as examples. The disclosed technology is the first UAV that incorporates an independent, separable, fully functional, rotorcraft with a modular, removably attached, fixed-wing airfoil assembly, thereby offering a single UAV that can operate as either a stand-alone rotorcraft or a VTOL fixed wing. The disclosed UAVs also provide structures and methods to adjust the center of mass of a fixed wing airfoil assembly and other components to coincide with the design center of gravity of the rotorcraft components. The disclosed UAVs also provide a modular propeller guard assembly whose center of mass can be adjusted to coincide with the center of gravity of a thrust producing assembly.

There have been attempts to design UAVs capable of performing as a multi-copter and as a fixed wing aircraft while retaining the desirable attributes of VTOL, hovering, relatively good payload capacity, and efficient horizontal flight. However, many designs attempting to combine multi-copter and fixed wing aircraft (e.g., hybrid designs) achieve VTOL, but with reduced payload capacity and ineffective hovering capability due to the added weight and weight distribution problems inherent in also carrying the fixed wing lifting surfaces, structural and flight control components. Other hybrid designs somewhat resolve the weight and weight distribution problems, but have reduced fixed wing flight efficiency due to the parasitic drag resulting from the size and location of the VTOL components along the lifting surfaces of the fixed wing.

The disclosed technology solves these problems by incorporating a wing planform and configuration, and a multi-copter or similar VTOL apparatus or system in an arrangement that: (1) eliminates the need for a conventional fuselage, thereby eliminating the associated contribution of added weight; (2) locates the center of gravity of a multi-copter or similar VTOL apparatus or components and the center of gravity of the wing assembly at a common point; (3) reduces the number, and therefore the weight, of structural components required for the wings, control surfaces and associated components; and (4) provides high lift to weight ratios without the need for longer wingspans or deeper chords, all of which results in a UAV capable of VTOL, hovering and horizontal flight with heretofore unachieved efficiency.

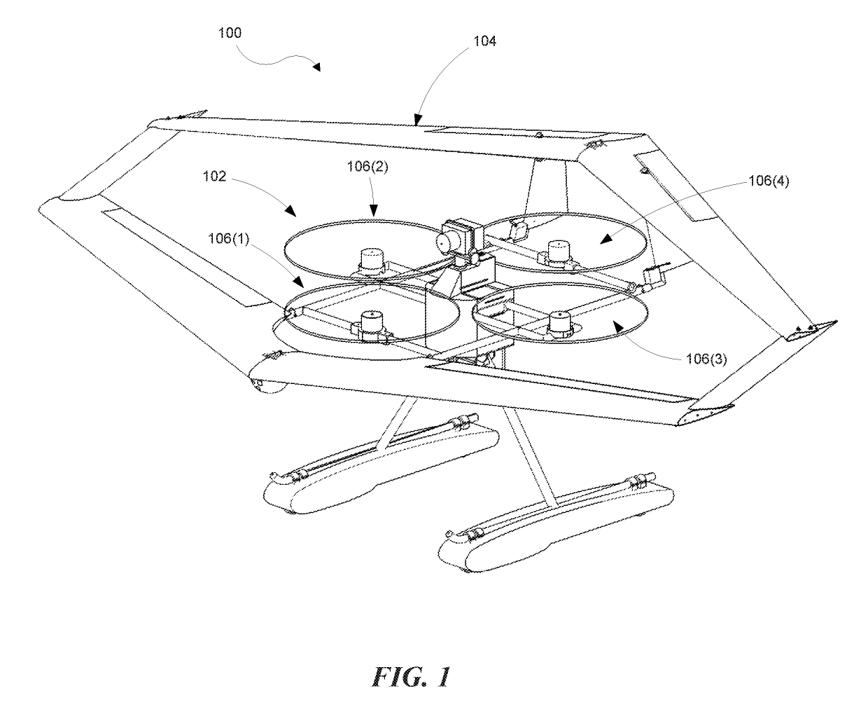

FIG. 1 illustrates a modular and reconfigurable UAV 100 with an adjustable center of gravity according to a representative embodiment. In the depicted configuration, the UAV 100 includes a VTOL apparatus, such as multi-copter assembly 102, and a wing assembly 104 removably coupled to the multi-copter assembly 102 so as to permit horizontal flight capabilities similar to that of a fixed wing aircraft.

The multi-copter assembly 102 includes a plurality of thrust assemblies, such as rotor assemblies 106 (shown schematically), to provide the capability of VTOL, hovering and horizontal flight. For example, the UAV may have four rotor assemblies 106 whose thrust is directed substantially downward and whose lift is directed substantially upward. The rotor assemblies 106 direct air downward in a controlled fashion, thus providing the machine the capability of hovering, loitering, vertical ascent and descent, and horizontal flight. Although the various embodiments are described with respect to rotor assemblies, any suitable thruster can be used, such as turbines, ducted fans, jets, or the like. Furthermore, although four rotor assemblies are shown and described herein, more or fewer thrusters can be used.

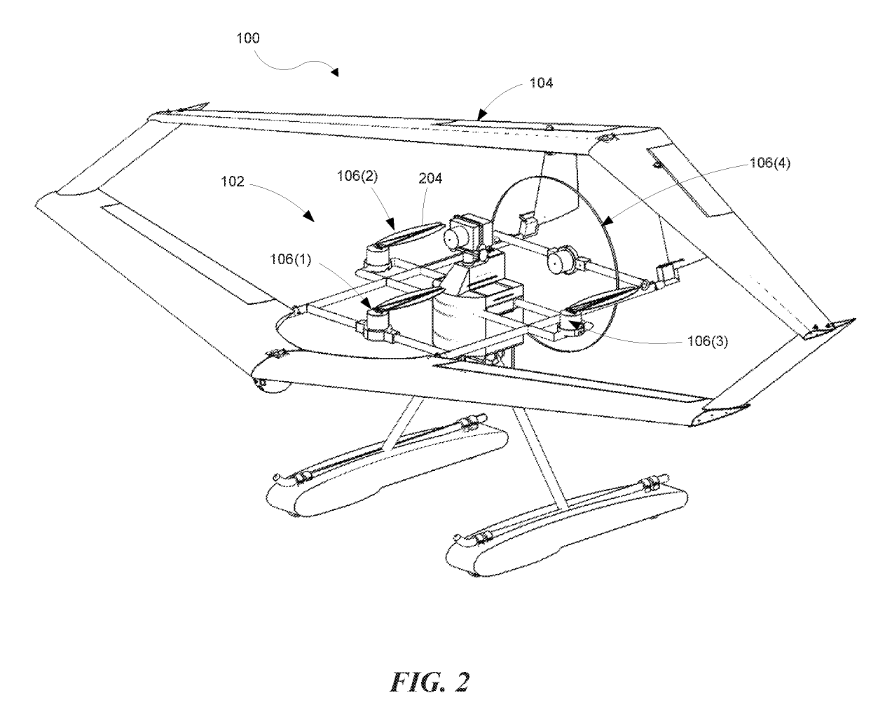

With further reference to FIG. 2, at least one of the rotor assemblies 106 can rotate approximately 90 degrees to transition from vertical thrust to horizontal thrust. For example, rotor assembly 106(4) is rotated 90 degrees with respect to horizontal to provide a horizontal thrust to propel the UAV in a forward horizontal direction. As the UAV 100 moves forward, air flows across wing assembly 104 to provide lift and efficient horizontal flight. As the wing assembly 104 takes over to provide vertical lift, one or more rotor assemblies 106 can be deactivated in order to reduce drag and conserve energy (e.g., battery life) while in horizontal winged flight. For example, rotor assemblies 106(1)-106(3) can be deactivated. In other words, the rotor assemblies' motors can be turned off. In some embodiments, the rotor assemblies include folding rotors 204 to further reduce drag when in horizontal flight. In some embodiments, this methodology can increase flight time from approximately 15 minutes in a VTOL configuration, to approximately 1.5 hours in the depicted winged horizontal flight configuration.

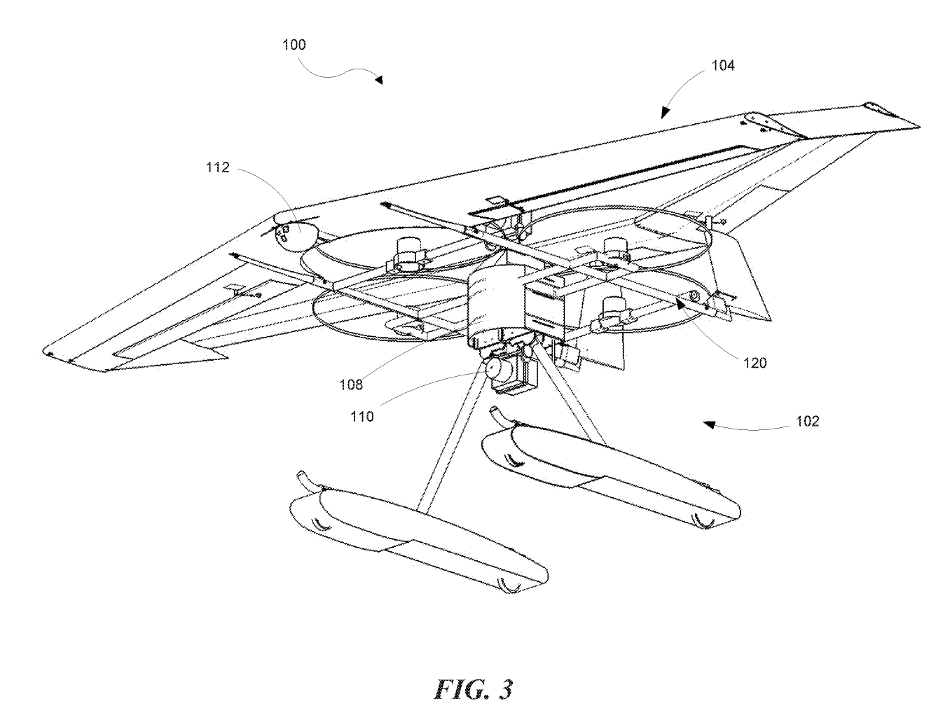

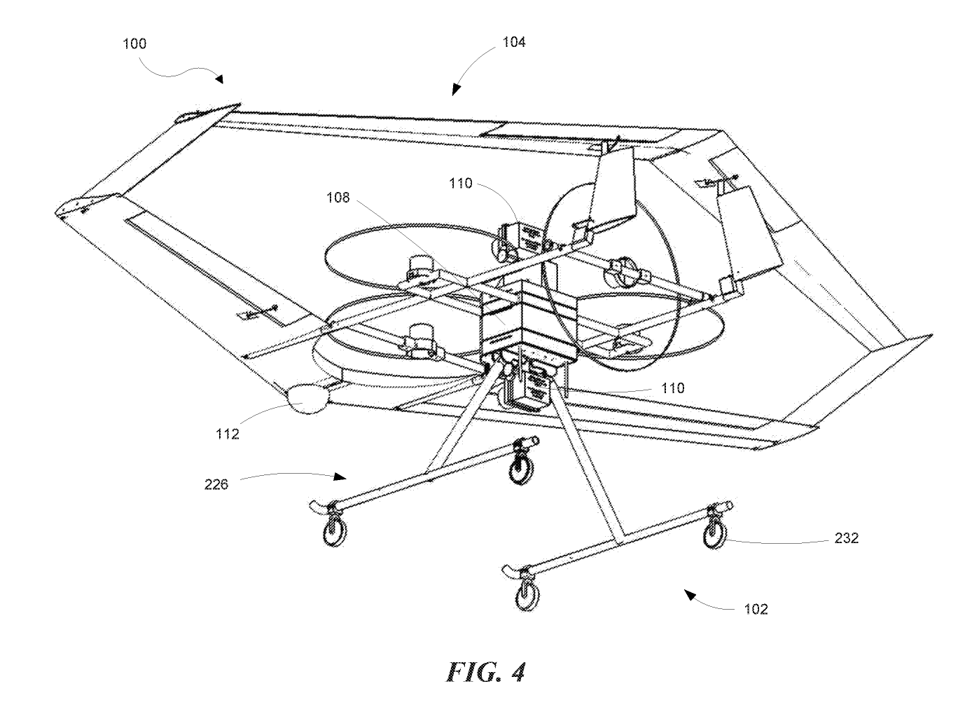

As shown in FIGS. 3 and 4, the multi-copter assembly 102 includes an airframe 120 comprising a plurality of tubular members arranged in a plane. In some embodiments, the airframe 120 can comprise lightweight carbon fiber tubes, metal alloy tubes, or any other suitable frame members. Although, the airframe 120 is depicted with a particular construction, other suitable frame structures can be used, whether they be planar, three dimensional space frame, or have different number and/or arrangement of frame members. The space frame 120 supports a control module 108 which houses a power supply, which may be in the form of one or more fuel cells, batteries, etc.; and radio, navigation, electronics equipment, and the like that may be necessary for flight control. The control module 108 can also serve as a payload platform to attach equipment such as cameras, sensors, scanners and the like. For example, cameras 110 can be attached to the control module 108, as shown. In some embodiments, devices can be attached to the UAV 100 at different locations. For example, a camera module 112 can be mounted to the wing assembly 104. As shown in FIG. 4, the multi-copter assembly 102 can include landing gear 226 having a plurality of wheels 232. This configuration can be useful when landing in a “conventional” fashion, such as the way an airplane typically lands on a runway, as opposed to landing vertically.

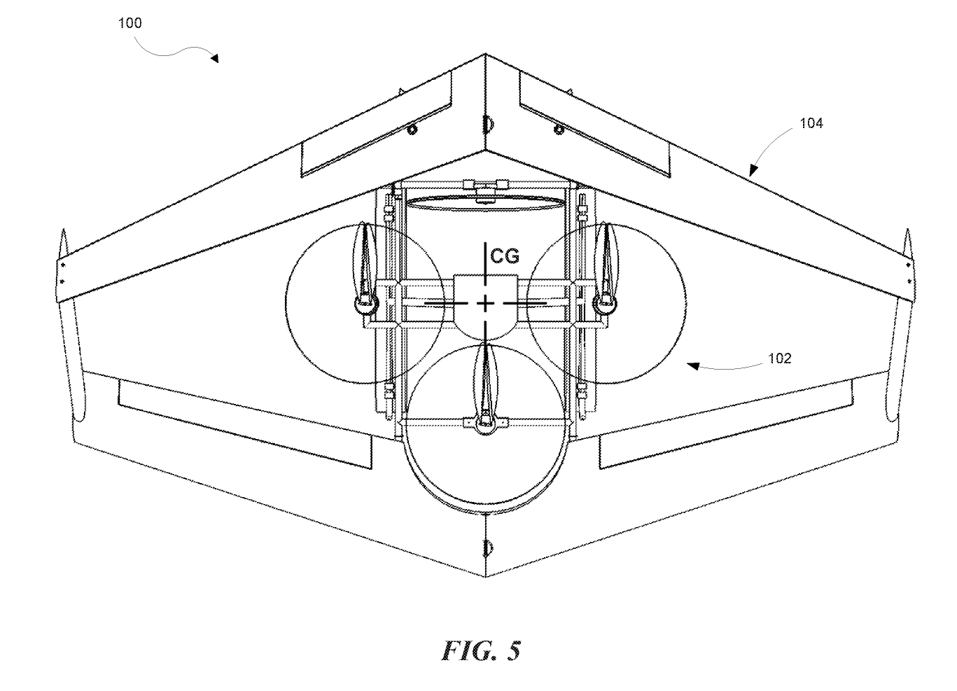

With reference to FIG. 5, the center of gravity CG of the multi-copter assembly 102 and the wing assembly 104 are located at a common point. It is desirable to position the centers of gravity at a common point so that the UAV is balanced in VTOL mode so that all of the rotor assemblies 106 operate at approximately the same load. In addition, during horizontal flight mode the UAV 100 needs to be balanced for the wing to operate at the proper angle of attack.

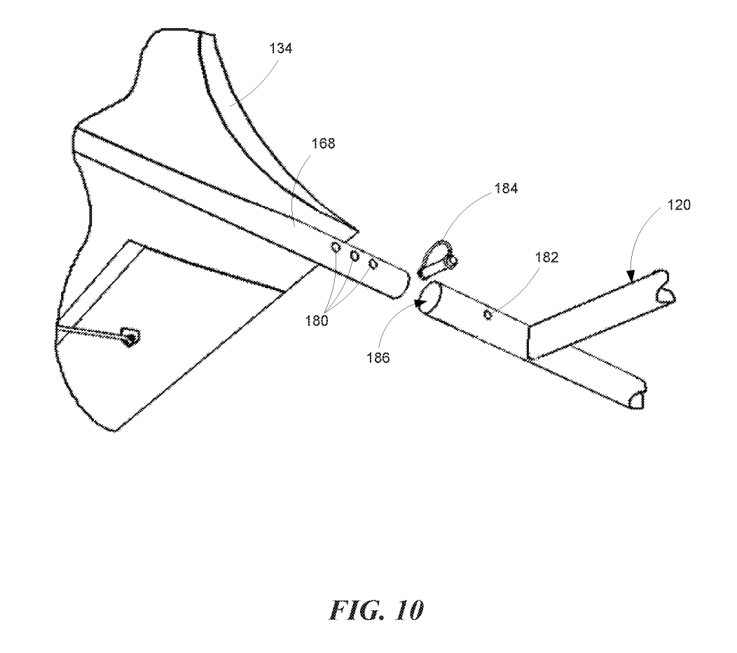

The diamond-shaped planform of the wing assembly 104 places the center of gravity in the middle of the wing assembly 104. The substantially symmetrical arrangement of the multi-copter assembly 102 results in its center of gravity being approximately in the middle (depending on payload position). Accordingly, the diamond-shaped wing assembly 104 and symmetrical multi-copter assembly 102 allow the centers of gravity of the two assemblies to be matched by positioning the multi-copter assembly 102 in approximately the middle or center of the wing assembly 104. It should be understood that as the UAVs payload is moved or changed, the center of gravity of the UAV may need to be adjusted in order to compensate. The multi-copter assembly 102 can be moved fore and aft relative to the wing assembly 104, as described more fully below with respect to FIG. 10, in order to compensate for payload changes.

Although the described embodiments are directed to a particular wing planform and multi-copter configuration, any suitable VTOL-capable system can be paired with any suitable wing planform that locates their respective centers of gravity CG at a common point, and that permits an increase in wing area without a corresponding increase in wing span or chord. Other suitable wing planforms can include, without limitation, round, square, oval, or triangular planforms, for example. And, in other embodiments, the fore wing may be higher than the aft wing, or they may be on the same plane. In still other embodiments, the wing assembly can be a bi-plane configuration, for example.

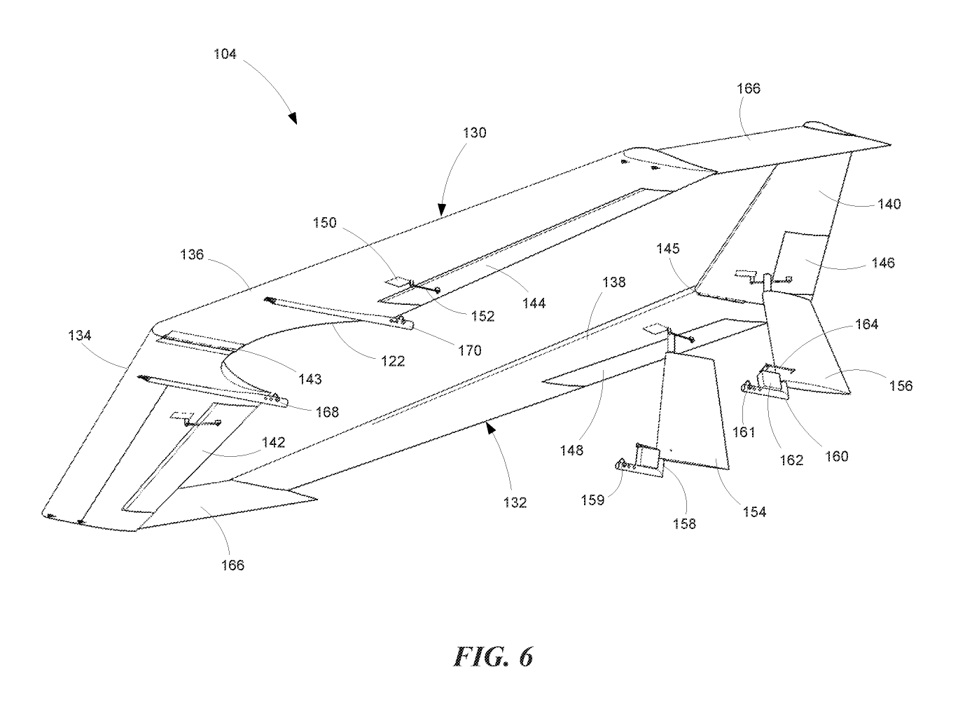

As shown in FIG. 6, the wing assembly 104 includes a forward or leading wing structure 130 and a rearward or trailing wing structure 132 connected together by vertical stabilizers 166. However, one skilled in the relevant art will understand and appreciate that the forward wing and rearward wing can be joined together without vertical stabilizers. This configuration of wing design is sometimes referred to as a closed wing, joined wing or box wing arrangement. In some embodiments, the forward wing 130 is positioned below the rearward wing 132. The forward wing structure 130 includes wings 134 and 136 coupled together by hinge 143. Rearward wing 132 includes wings 138 and 140 coupled together with hinge 145. The forward wing 130 includes control surfaces 142 and 144 and rearward wing 132 includes control surfaces 146 and 148. The control surfaces can be actuated with suitable servos, such as servo 150 and associated linkage arm 152. Although the flight control capabilities of the wing assembly 104 are shown with particular control surfaces and servo arrangements, other suitable control mechanisms can be used.

In some embodiments, one or more of the wings can include an open region to provide clearance for the rotor assemblies 106. For example, forward wing 130 includes clearance region 122 to provide clearance for rotor assembly 106(1) (FIG. 2). A pair of rudders 154 and 156 are pivotably mounted on corresponding rudder axles 158 and 160, respectively. The rudders 154, 156 can be actuated with suitable servos mounted on the rudder axles 158, 160. For example, rudder 156 is actuated by servo 162 and associated linkage 164.

The forward wing 130 and the rearward wing 132 each include structures for removably coupling the wing assembly 104 to the multi-copter assembly 102. The forward wing includes wing connectors, such as spars 168 and 170, and the rearward wing 132 includes rudder connectors, such as spars 159 and 161, each extending from a corresponding rudder axle 158 and 160. The spars connect to the airframe 120 (FIG. 3) of the multi-copter 102 as described more fully below with respect to FIG. 10. In some embodiments, the wings can include an inner core comprised of lightweight expanded polystyrene (EPS) foam, stiffened with carbon fiber spars, and encased in carbon fiber sheathing. Other suitable materials and methods of wing construction can be employed to create lightweight, strong wings and associated components.

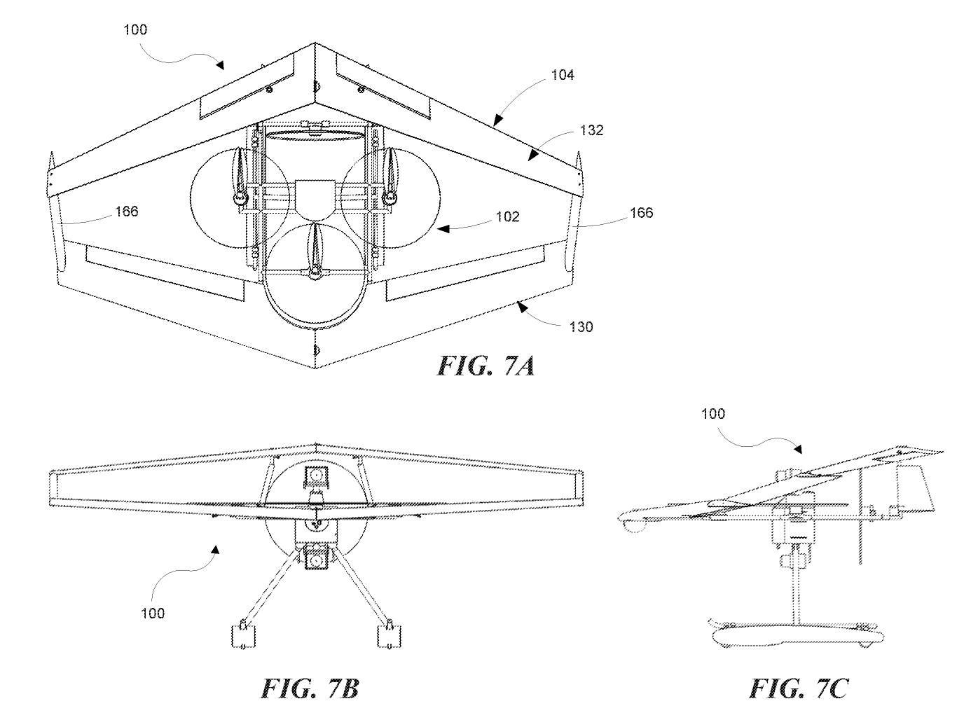

FIGS. 7A-7C illustrate the arrangement of the various above described wing components with respect to each other and with respect to the multi-copter assembly 102. The disclosed wing assembly 104 provides a wing structure with high lift coefficients and low stall speeds by pairing the wings 130 and 132, and the vertical stabilizers 166. In conventional winged UAVs, a fuselage common in form and function to that of a conventional aircraft, occupies the center or middle area of a closed wing arrangement, and to which the wings are joined. However, in the disclosed UAV 100, the fuselage is removed and replaced by the multi-copter assembly 102.

Removing the fuselage serves to remove a substantial portion of the total mass of the aircraft, thus serving to reduce the weight of the aircraft to that of only the wing structures. The multi-copter components are joined to the wing structures by way of a lightweight framework, the total weight of such framework being only marginally greater than the weight of the framework required to join the components of the multi-copter in its original form. In a representative embodiment, the weight of the wings, along with the weight of the additional framework required to join the multi-copter to the wings is well within the lifting capacity of the multi-copter at 50% throttle. The result is that the multi-copter is capable of efficiently lifting and hovering while joined to the wing structures, with a useful payload (e.g., approx. 13 lbs.). In addition, the wing assembly 104 is capable of providing sufficient lift to carry the multi-copter components plus the payload when in forward flight.

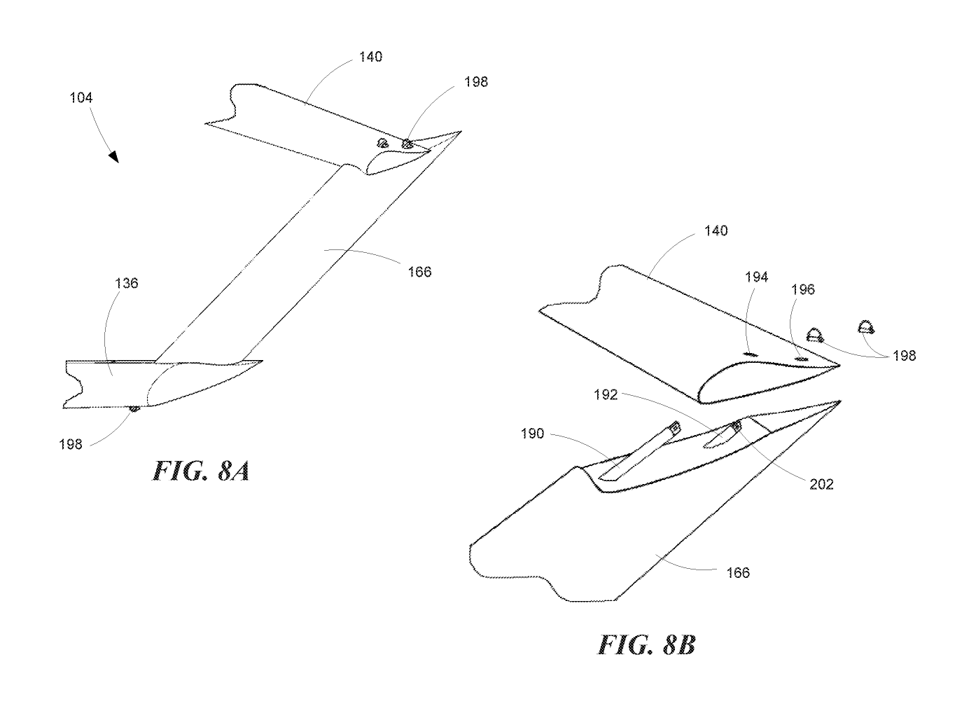

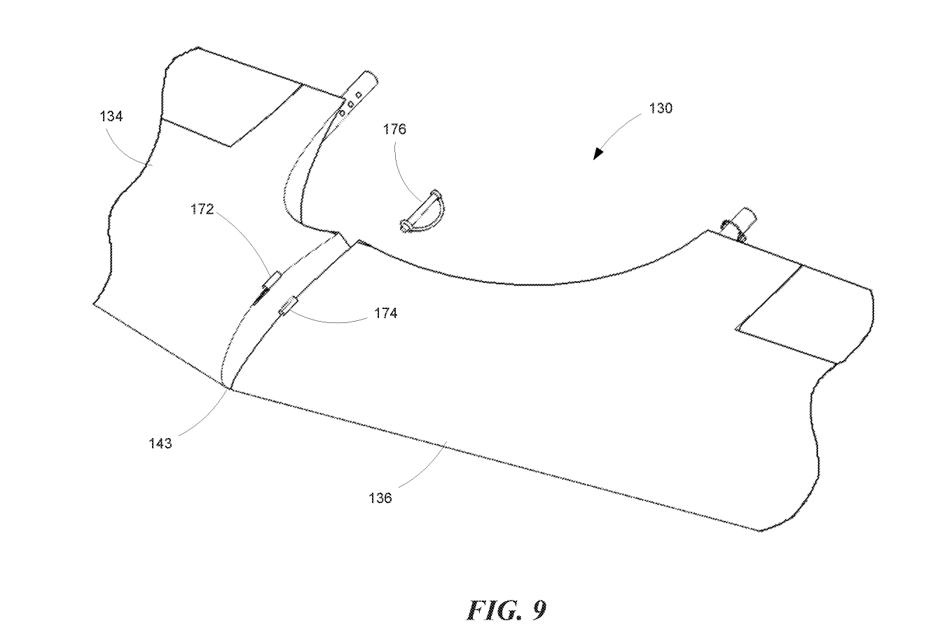

As shown in FIGS. 8A-9, the wing assembly 104 can be disassembled for transport and/or repair by separating the wings, e.g., wings 136 and 140, from their associated vertical stabilizers 166 by removing pins 198. For example, as shown in FIG. 8B, the vertical stabilizer 166 includes mounting spars 190 and 192 insertable into mating mounting bores 194 and 196 formed through the tip of wing 140. The pins 198 extend through apertures 202 formed through the ends of spars 190 and 192 to retain the wing 140 on the vertical stabilizer 166. In order to further facilitate storage and transport, the forward and rearward wings 130 and 132 can be folded to reduce their overall length. As shown in FIG. 9, the wing portions 134 and 136 of the forward wing 130, for example, can be folded together about hinge 143 by removing linchpin 176 from cooperatively mating knuckles 172 and 174. In some embodiments, the joining spars can be constructed of carbon fiber, metal alloy, or other suitable lightweight, yet strong, materials.

When the wing assembly 104 is attached to the multi-copter 102, it is desirable for the multi-copter's center of gravity to remain at its center of mass. Slight variations or inconsistencies between the mass of the forward wing 130 and the mass of the rearward wing 132 can result in the center of gravity of the total mass of the wing assembly 104 being off-center in reference to the center of gravity of the multi-copter 102. In order to compensate for this potential shift in center of gravity, the multi-copter assembly 102 can be moved fore and aft relative to the wing assembly 104. As shown in FIG. 10, the airframe 120 includes receptacles 186 configured to receive a corresponding wing spar 168. The wing spar 168 is retained in receptacle 186 with a linchpin 184, or similar device, extending through mounting hole 182. The position of the wing assembly 104 with respect to the multi-copter 102 is adjusted by aligning one of the adjustment holes 180 with mounting hole 182 and inserting the linchpin 184, thereby locking the wing assembly 104 and the airframe 120 together. Thus, the spars 168 are slidable within the receptacles 186 and securable therein at multiple longitudinal positions. In some embodiments, the adjustment holes 180 can be located in either the wing spar 168 or the airframe 120 and positioned linearly, front to rear. In some embodiments, the adjustment holes 180 can be set at a prescribed pitch of approximately 0.5 inches, for example, to permit the wing structure to be shifted front to back in relation to the center of the multi-copter 102, and then locked into place with the linchpins 184, thus permitting the center of gravity of the wing assembly 104 to be adjusted to more precisely align with the center of gravity of the multi-copter 102. In some embodiments, the spars 168 can be clamped in position within their corresponding receptacles 186.

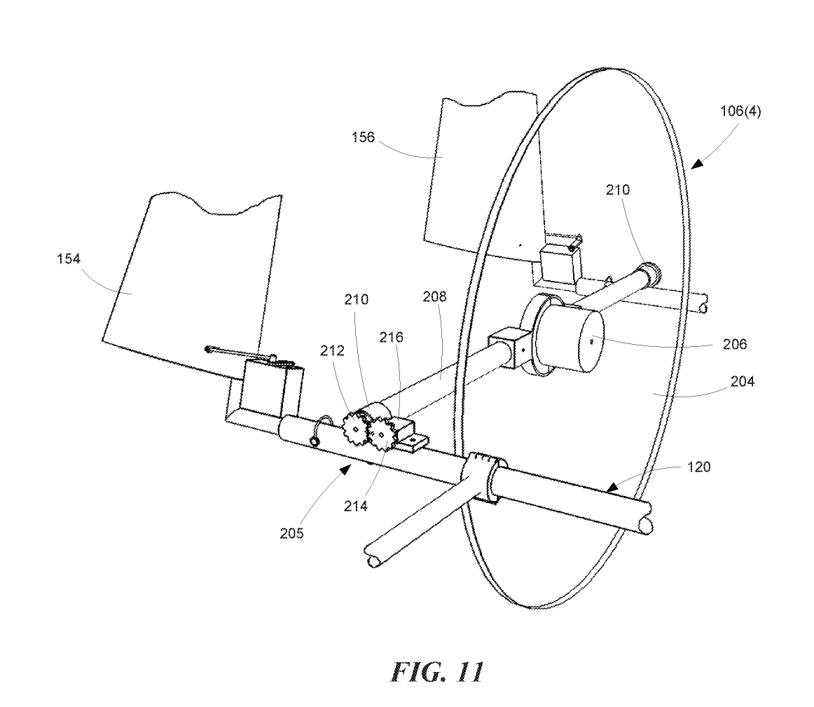

As shown in FIG. 11, rotor assembly 106(4) is connected to a positioning mechanism 205 for changing the angle of the rotor assembly 106(4). The positioning mechanism 205 rotates the rotor assembly 106(4) between horizontal and vertical orientations to position the rotor assembly 106(4) for VTOL or horizontal propulsion. The rotor assembly 106(4) includes a motor 206 and a prop 204. The motor 206 is connected to a shaft 208 that rotates within bearing collars 210 attached to the frame at either end of the shaft 208. A positioning servo 216 rotates the shaft 208 via spur gears 212 and 214. Accordingly, the rotor assembly 106(4) can be positioned as desired by operation of the positioning servo 216. Any number of suitable arrangements and mechanisms capable of rotating the rotor assembly can be used. For example, the positioning mechanism can comprise servo arms, chain drives, and/or the like.

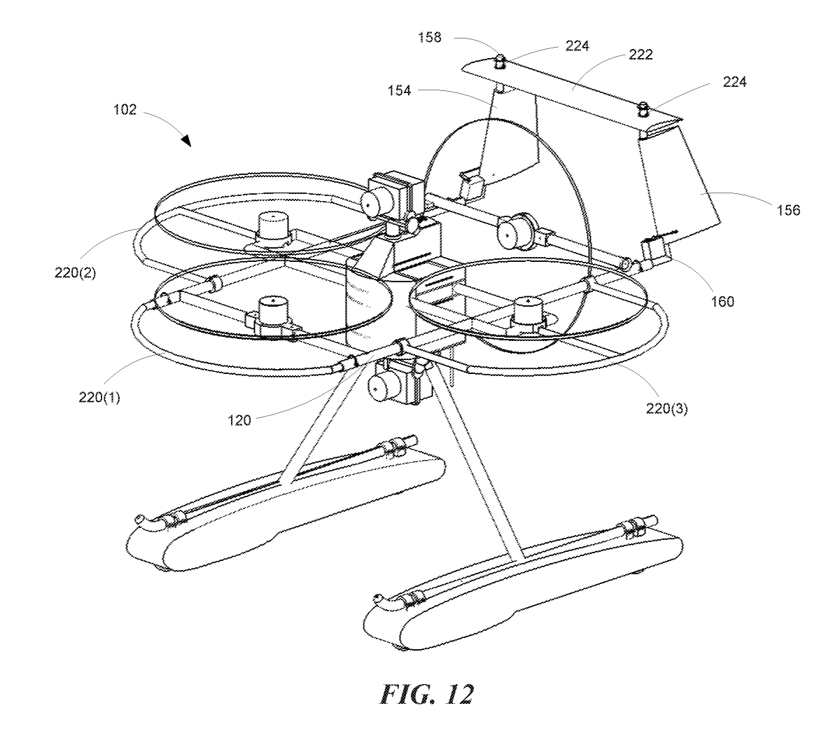

FIGS. 12-14 illustrate alternative configurations of the UAV 100 according to the modular aspects of the disclosed technology. For example, FIG. 12 illustrates the multi-copter 102 configured without the wing assembly 104. Instead, a horizontal stabilizer 222 is mounted to the rudder axles 158 and 160 that extend through mounting holes 224 formed through the stabilizer 222. Horizontal stabilizer 222, along with rudders 154 and 156, can provide navigation control during water surface operations, and some lift for horizontal flight, although not to the same extent as the wing assembly 104. This configuration may be suitable for marine operations where long periods of operation on the surface of water may be required, but only short periods in the air, along with the ability to take off and land vertically. Several prop guards 220(1)-220(3) can be connected to the airframe 120 to protect the propellers from solid obstacle strikes, thus allowing the UAV 100 to safely operate in more confined or space restricted areas that pose the possibility of such strikes.

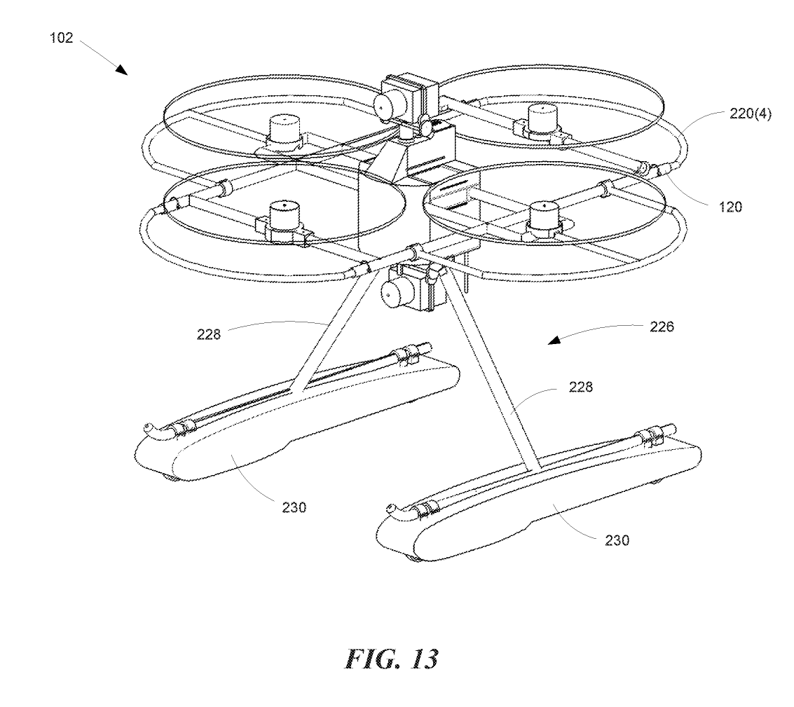

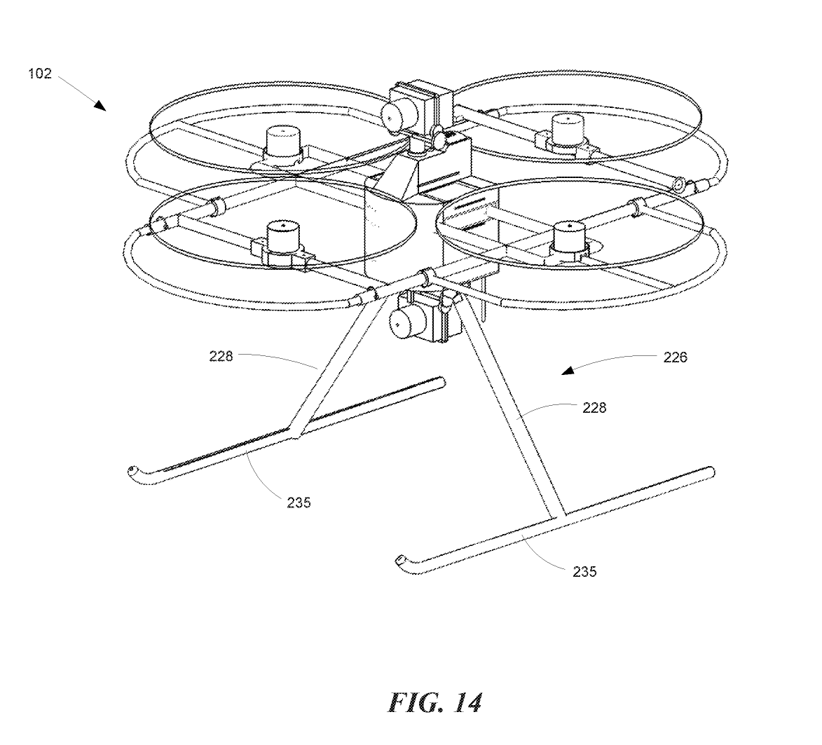

FIG. 13 illustrates another configuration of the multi-copter 102. In this configuration, the rudders 154, 156 and horizontal stabilizer 222 are replaced by an additional prop guard 220(4). The prop guards 220 can be connected to the airframe 120 in a similar manner to that explained above with respect to the wing assembly 104 and in reference to FIG. 10. In the various configurations described herein, the multi-copter 102 can include landing gear 226. The landing gear 226 can include downward projecting struts 228 with various suitable attachments. For example, in the depicted embodiment, the landing gear includes modular flotation units or pontoons 230 for landing on and moving along a body of water. In other embodiments, such as that shown in FIG. 14, the landing gear 226 can include landing skids 235 for landing on various surfaces. In some embodiments, the landing gear 226 can include wheels, pontoons or both wheels and pontoons (e.g., FIG. 3).

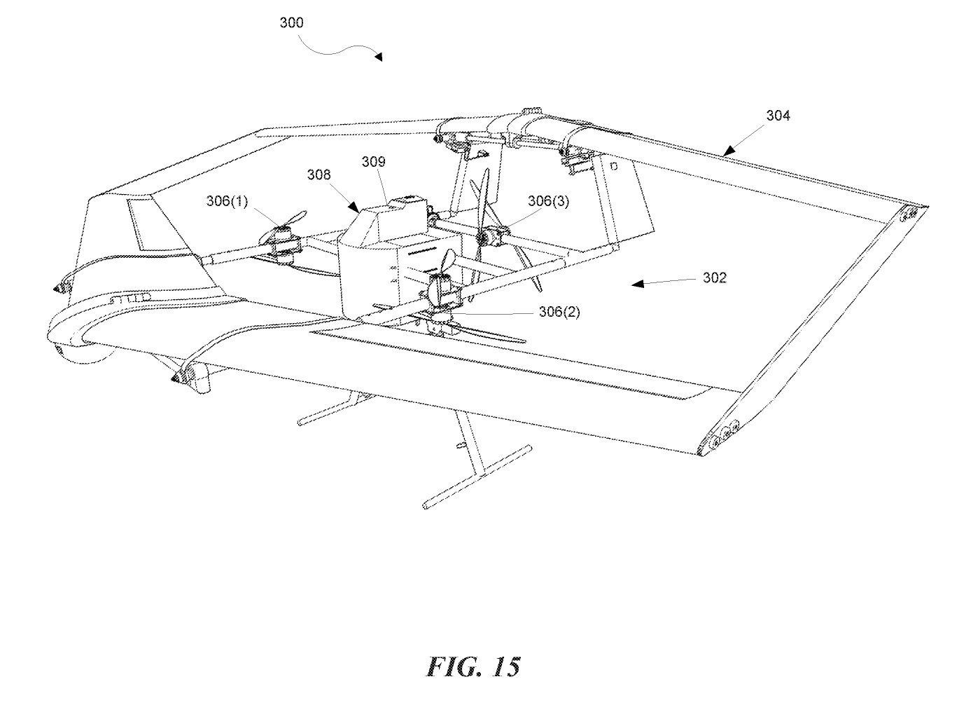

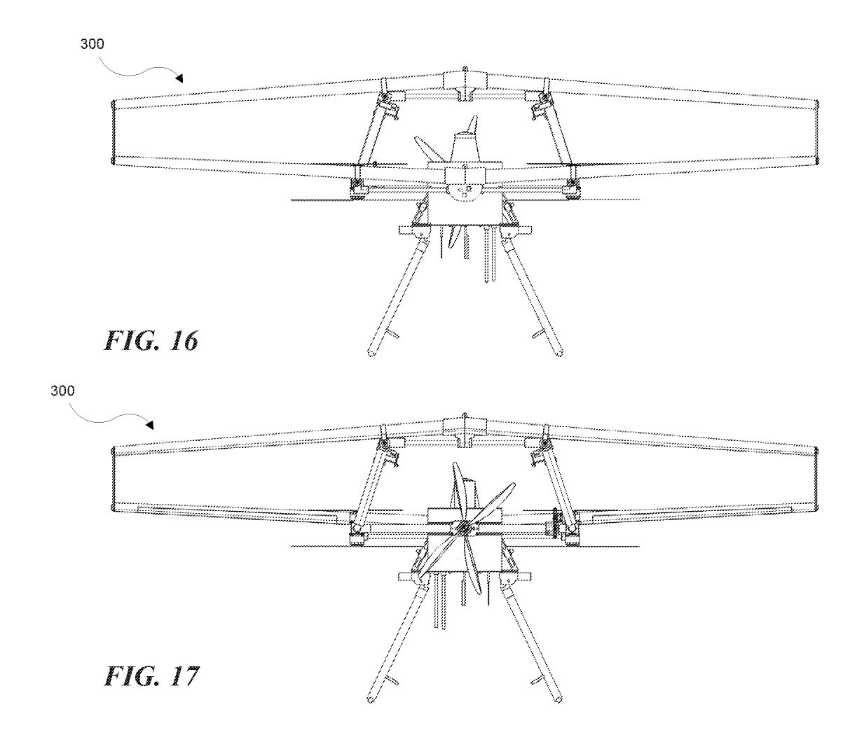

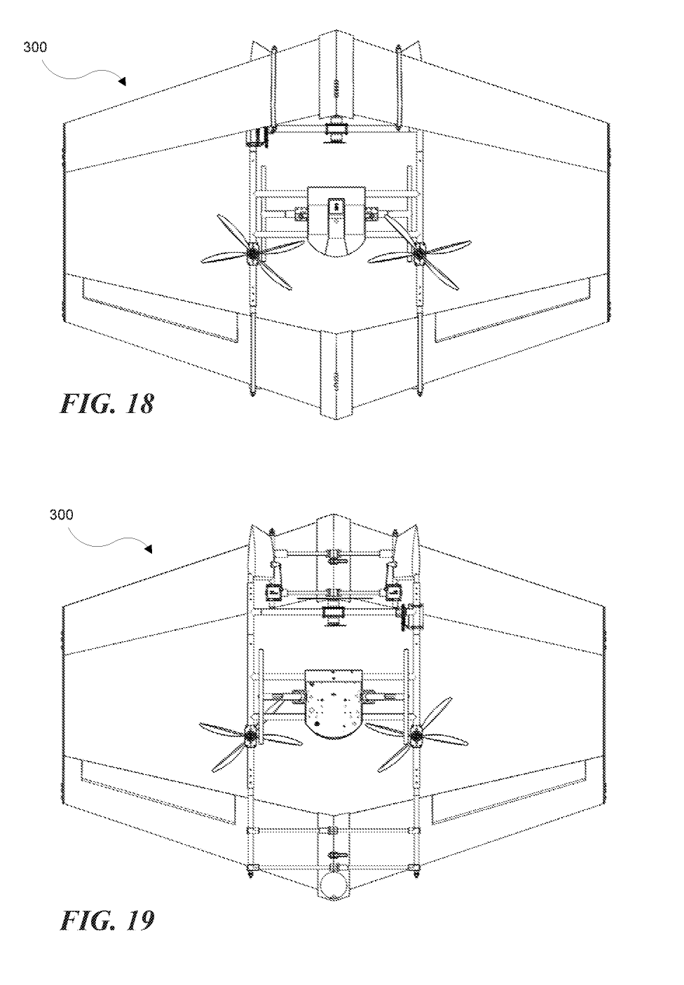

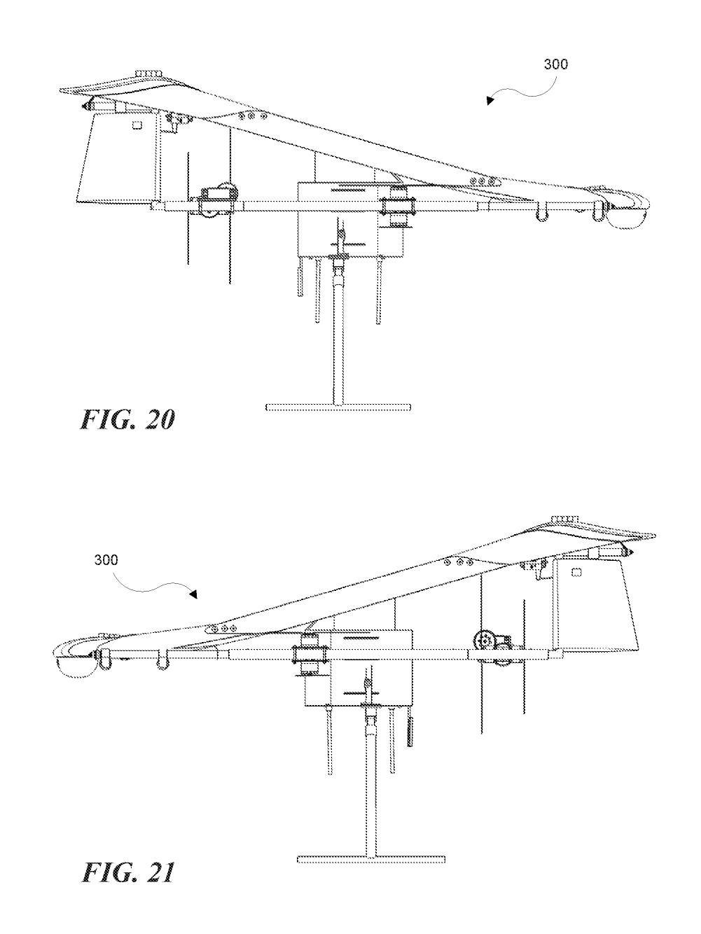

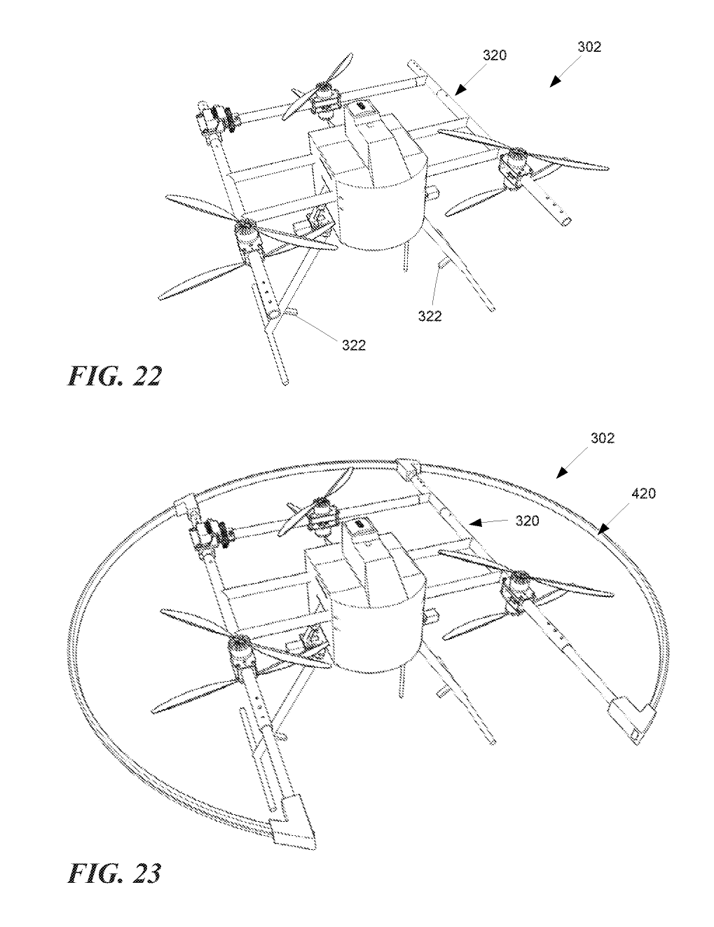

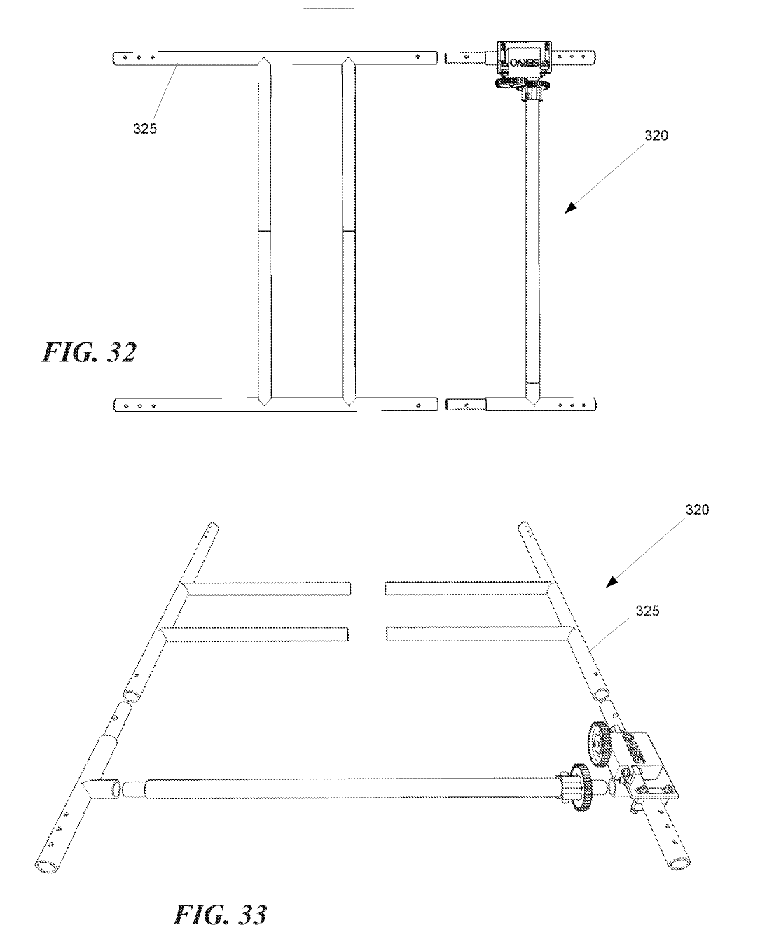

FIGS. 15-42 illustrate a modular and reconfigurable UAV 300 with an adjustable center of gravity according to a representative embodiment. The UAV 300 is similar in many respects to the UAVs described above. Some features that may be different from the above described UAVs are highlighted below. However, it should be appreciated that features of the various UAVs described herein can be combined in any suitable combination. In the depicted configuration, the UAV 300 includes VTOL apparatus, such as multi-copter assembly 302, and a wing assembly 304 removably coupled to the multi-copter assembly 302 so as to permit horizontal flight capabilities similar to that of a fixed wing aircraft. In some embodiments, the multi-copter assembly 302 can include three thrust assemblies, such as rotor assemblies 306(1), 306(2), and 306(3) (collectively rotor assemblies 306), each including two rotors in tandem in a triangle configuration, as shown. As shown in at least FIG. 15, the aft rotor assembly 306(3) is rotated to provide thrust in the horizontal plane. In some embodiments, the control module 308 can include a cover 309 and a GPS unit may be attached to the cover. As perhaps best shown in FIG. 22, the landing gear can include antenna 322.

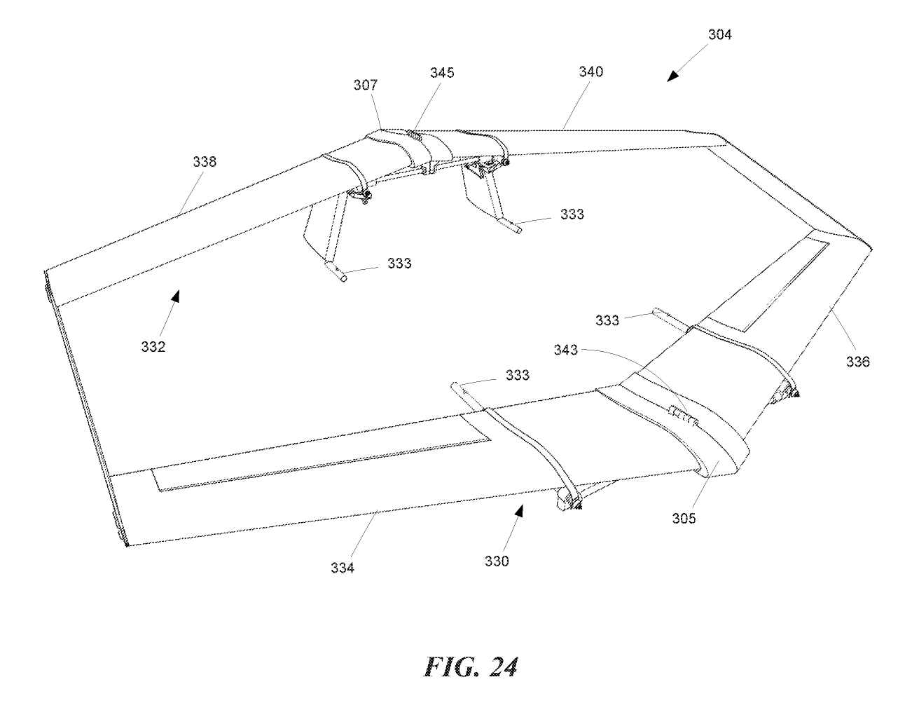

One skilled in the relevant art will understand and appreciate that for the purposes of this disclosure, it is not necessary to describe every detail for constructing or fabricating common wings. In a representative embodiment, a first wing 330 and a second wing 332 (the wings) are used, as shown in FIG. 24. Each wing can be comprised of two half-wings that are joined at a common root face, to form a whole wing. The wings can use a core of one-pound EPS and have a span of 57.1 inches, root chord of 8.2 inches, a tip chord of 5.1 inches and utilize the LA2573A airfoil. In some embodiments, the first wing 330 is located forward of the second wing 332, has a setback (rearward sweep) of 9.67 inches, and dihedral angle of 2.8 degrees. The second wing 332 can be located 815.3 mm aft of the first wing 330 and at an elevation of 201.5 mm above the plane of the first wing 330. The root and tip chords and the airfoil of the second wing 332 can be identical to that of the first wing 330. The dihedral angle of the second wing 332 can be negative (anhedral) 5.3 degrees and have a setback of negative 11.924 inches (forward sweep). The first wing 330 and the second wing 332 can include a 4 mm diameter spar comprised of a carbon fiber rod spanning the length of the wing from the wing's root to the wing's tip, located 1.54 inches aft of the leading edge at the wing's root and 0.77 inches aft of the leading edge at the wing's tip. In some embodiments, the EPS wing cores can be sheathed with first a 1 mil layer of paper, glued onto the core, then with a 1 mil layer of carbon fiber weave material infused with epoxy resin and adhered to the paper layer, then with a 1 mil layer of carbon fiber/Kevlar weave material infused with epoxy resin and adhered to the carbon fiber weave layer.

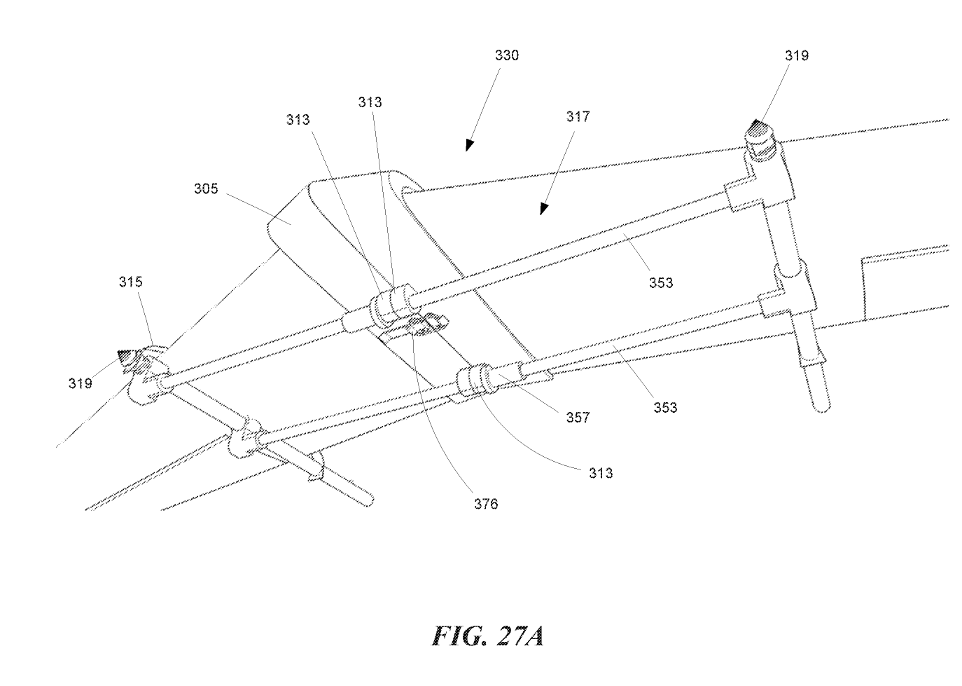

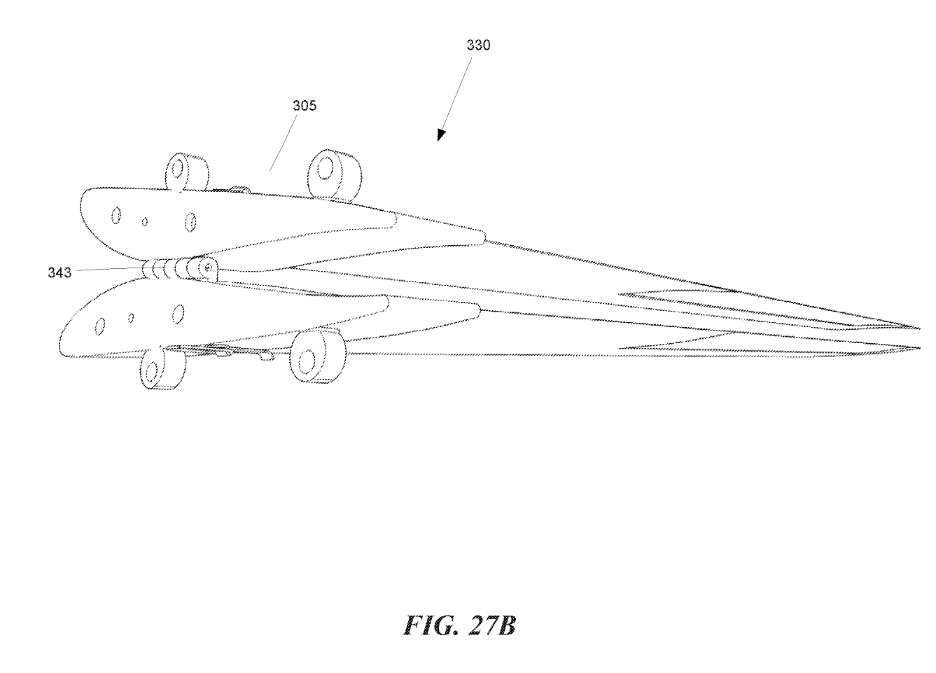

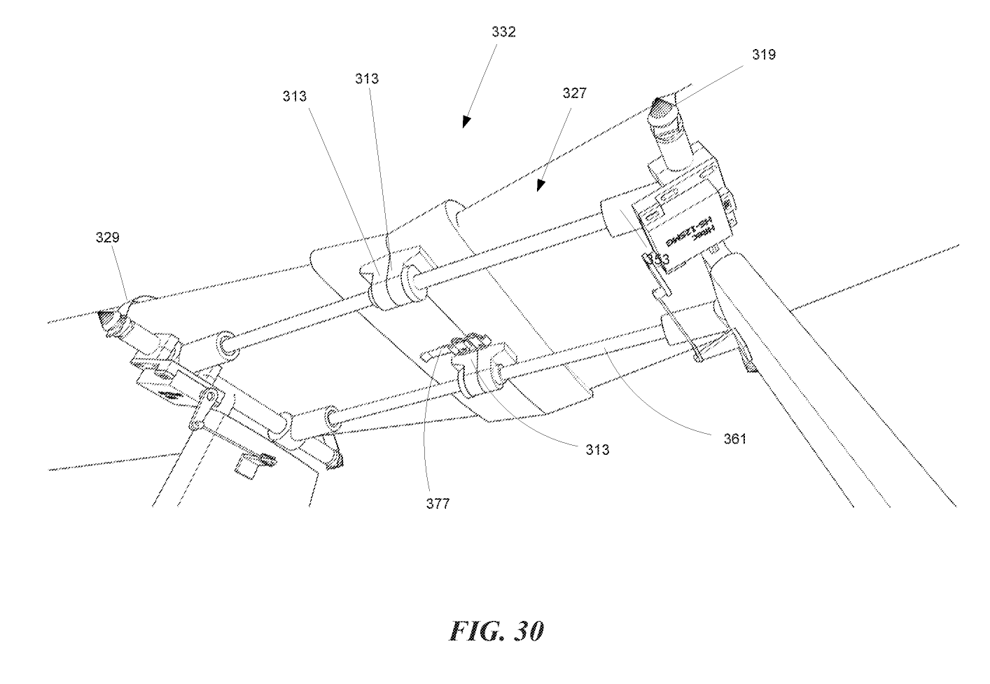

As perhaps best shown in FIG. 24, boots or wing joiner units 305 and 307 are located at the junctions of the fore and aft wing halves 334/336 and 338/340, respectively. The wing joiner units 305 and 307 provide a rotatable connection for the wing halves and provides protection for the wing noses (e.g., wing roots). In some embodiments, there is a hinge 343/345 positioned on top of the wings, enabling the wing halves to fold for storage, etc. (FIG. 27B), and a buckle clasp 376/377 (see e.g., FIGS. 27A and 30) on the bottom that locks the wings in the operational position. In some embodiments, the boots 305/307 can be 3d printed plastic or other suitable material, for example. In some embodiments the wing joiner units 305 and 307 can be glued into place onto their respective wing roots.

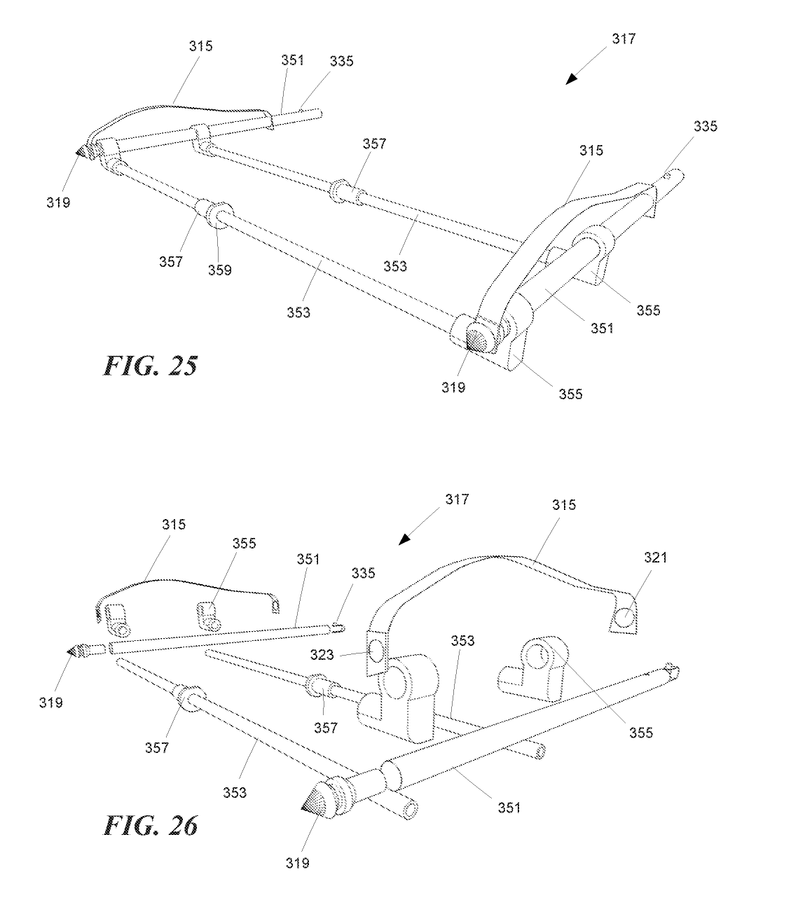

With reference to FIGS. 25-27A, the forward wing 330 can be coupled to the multi-copter assembly 302 via wing-to-airframe joining assembly or mounting frame 317. In some embodiments, the wing-to-airframe joining assembly 317 can be comprised of two longitudinal tubes 351 having an anterior and a posterior end, and positioned parallel to and in alignment with corresponding ends of the UAV's airframe tubes. The mounting frame 317 can include two transverse tubes 353 having a left and right end, and extending transverse to the two longitudinal tubes 351. The longitudinal tubes 351 and transverse tubes 353 can be connected together with suitable connectors, such as tube connectors 355 as shown in e.g., FIGS. 25 and 26. As shown in FIG. 27A, in some embodiments, the boot 305 can include receiver eyelets 313 on the bottom, through which the lateral tubes 353 of the wing frame are inserted, thus coupling the wing frame to the wings.

In some embodiments, tube position blocks 357 can be positioned along the transverse tubes 353 in order to center the forward wing 330 on the airframe. The tube position blocks 357 can each have an orifice, sized and shaped to accommodate a corresponding transverse tube 353, and a flat edge or face 359 sized and shaped to compliment and correspond to a face of the corresponding receiver eyelets 313 (e.g., see FIG. 27A).

In some embodiments, two bands or straps 315 help secure the wings to the mounting frame 317. In a representative embodiment, the bands 315 can be rubber, leather, or other suitably pliable, stretchable, lightweight material. In some embodiments, the bands 315 are positioned on the frame 317 through a first attachment hole 321 and a second attachment aperture 323 can be removably engaged with a point fitting 319. Accordingly, the wings can be easily secured to or released from the frame 317 by engaging or disengaging the bands 315 from their respective point fittings 319. In some embodiments, the point fittings 319 can be comprised of plastic, carbon fiber, aluminum or other sufficiently rigid, lightweight material, and can be shaped or molded, such as with a CNC machine or 3D printer, to precisely fit into the end of a corresponding longitudinal tube 351. In some embodiments, the point fittings 319 can have a point or other aerodynamically beneficial shape.

In a representative embodiment, the longitudinal and transverse tubes 351/353 can be comprised of carbon fiber, aluminum or other suitable lightweight, rigid material, and can be round, square or otherwise suitably shaped. The connectors 355 can be comprised of plastic, carbon fiber, aluminum or other sufficiently rigid, lightweight material, and can be shaped or molded, such as with a CNC machine or 3D printer, to precisely accommodate the respective tubes. The tube position blocks 357 can be comprised of plastic, carbon fiber, aluminum or other sufficiently rigid, lightweight material, and can be shaped or molded, such as with a CNC machine or 3D printer, to precisely accommodate, position and secure two transverse tubes 353 in position in the corresponding wing joiner unit receptacles. In a representative embodiment, the forewing-to-airframe joining assembly 317 can include longitudinal and transverse tubes 351/353 having an outside diameter of 12 mm and an inside diameter of 9.5 mm. In some embodiments, a spring button clip 335 can be affixed to each of the longitudinal tubes 351, 15 mm forward of the anterior end of the longitudinal tube to facilitate attaching the wing to the airframe 320.

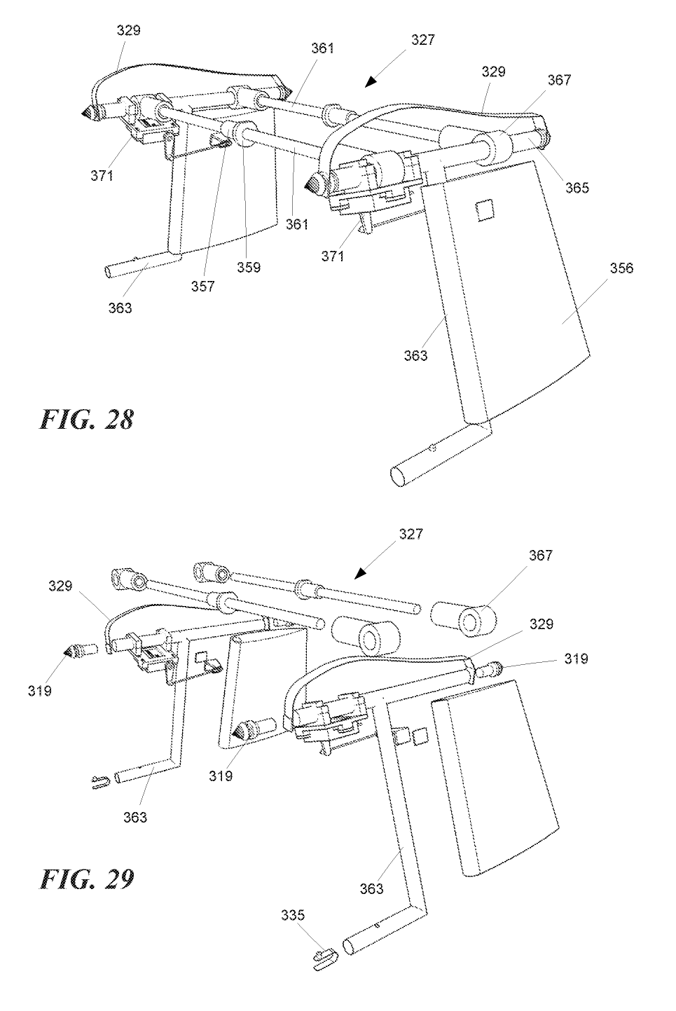

With reference to FIGS. 28-30, the rearward wing 332 can be coupled to the multi-copter assembly 302 via a wing-to-airframe joining assembly or mounting frame 327. Similar to the forward wing 330, the rearward wing 332 can be secured to the mounting frame 327 with bands 329 removably engaged with corresponding point fittings 319.

In some embodiments, the wing-to-airframe joining assembly 327 can be comprised of tube frame components including transverse tubes 361 having a right end and a left end, and “L” shaped tubes 363 joined to upper longitudinal tubes 365 having an anterior end and a posterior end. The “L” shaped tube can have an upper end, a middle shaft, and a lower end, the lower end having an elbow and an anterior end; the upper end of the “L” shaped tube can be joined to a corresponding upper tube 365 midway between the upper tube's anterior and posterior ends. The anterior end of the lower end of the “L” shaped tube can be positioned parallel to and in alignment with corresponding ends of a UAV's airframe tubes. In a representative embodiment, tube connectors 367 can be used to connect the transverse 361 and upper longitudinal tubes 365.

In some embodiments, a rudder 356 can be movably affixed to the middle shaft of the “L” shaped tubes 363 along with a servo mechanism 371 affixed near the anterior end of the upper tube, and connected via linkage to the rudder. One familiar with the art will understand the function of a rudder, that in other suitable airfoil configurations a rudder is not required, and that, if a rudder is included, that the rudder can be any appropriately sized and shaped rudder-like component, and can be affixed to the middle shaft of the “L” shaped tube by any means suitable to permit proper functionality of the rudder.

In some embodiments, tube position blocks 357 can be positioned along the transverse tubes 361 in order to center the aft wing 332 on the airframe 320. The tube position blocks 357 can each have an orifice, sized and shaped to accommodate a corresponding transverse tube 361, and a flat edge or face 359 sized and shaped to compliment and correspond to a face of the corresponding receiver eyelets 313 (e.g., see FIG. 30).

In a representative embodiment, the aft wings-to-airframe joining assembly can include two each upper and “L” shaped tubes, having an outside diameter of 12 mm and an inside diameter of 9.5 mm. In some embodiments, a spring button clip 335 can be affixed to the anterior ends of each lower end of the “L” shaped tubes, approximately 15 mm aft of the anterior end to facilitate attaching the wing to the airframe 320. Once the aft wings-to-airframe joining assembly (joining assembly) is attached to the aft wing joiner units as described, forming an aft wing airfoil assembly, the anterior ends of the wings-to-airframe joining assembly can be removably and adjustably inserted into corresponding posterior ends of a UAV's airframe.

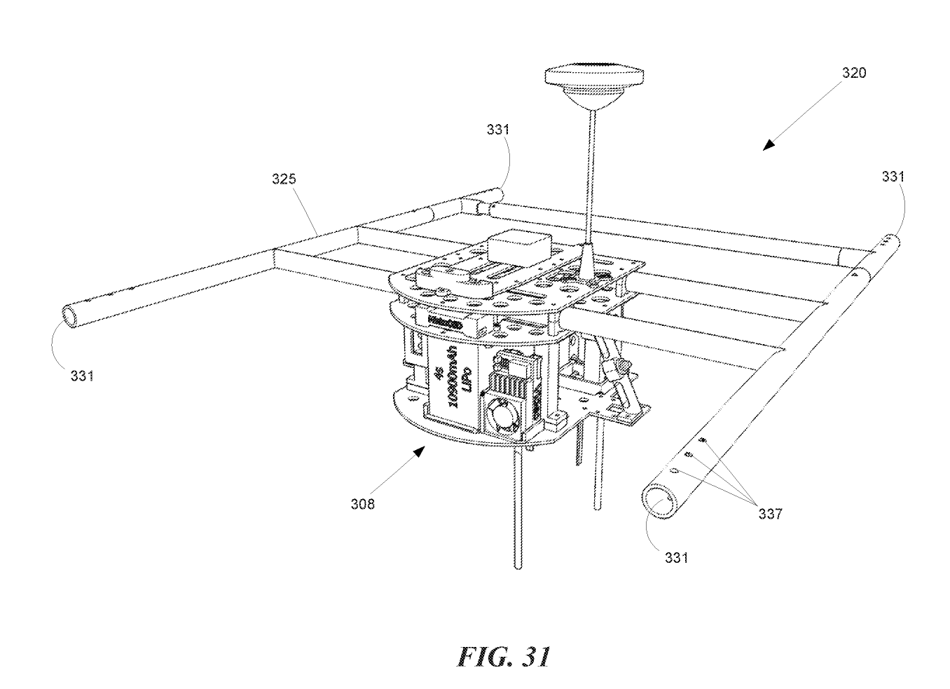

With reference to FIGS. 31-33, in a representative embodiment, the multi-copter assembly 302 (e.g., FIGS. 22 and 23) can be designed to serve as the thrust producing mechanism providing lift and/or horizontal propulsion for a VTOL fixed wing UAV. In some embodiments, the multi-copter assembly 302 can include an airframe 320, the size and shape of which can offer the ability to interchangeably and removably attach a modular wing airfoil assembly 304 (e.g., FIG. 24) and a propeller guard assembly 420 (FIG. 23).

In some embodiments, the airframe 320 can include frame tubes, such as tube 325, comprised of carbon fiber, aluminum or other suitable lightweight, rigid material, and can be round, square or otherwise suitably shaped. The airframe 320 can include receivers 331 whereby the airfoil assembly 304 and the propeller guard assembly 420 may be attached. The airfoil assembly 304 and the propeller guard assembly 420 can include attachment tubes 333 (FIGS. 24, 36, and 37) having ends that can be inserted into the receivers 331. The receivers 331 can have an inner diameter sized to accommodate corresponding attachment tube ends 333. The inner diameter of the receivers 331 and the outer diameter of the attachment tube ends 333 can be such that there is a free space that allows the attachment tube ends to be inserted into the receivers to a depth sufficient to provide a structurally sound connection. In some embodiments, the control module 308 can function as a structural component of the frame, binding together the halves of a two-part frame, for example. In a representative embodiment, the airframe tube receivers 331 can have an inner diameter of 12.125 mm, for example. The corresponding attachment tube ends 333 of the airfoil assembly and of the propeller guard assembly have an outer diameter of 12 mm.

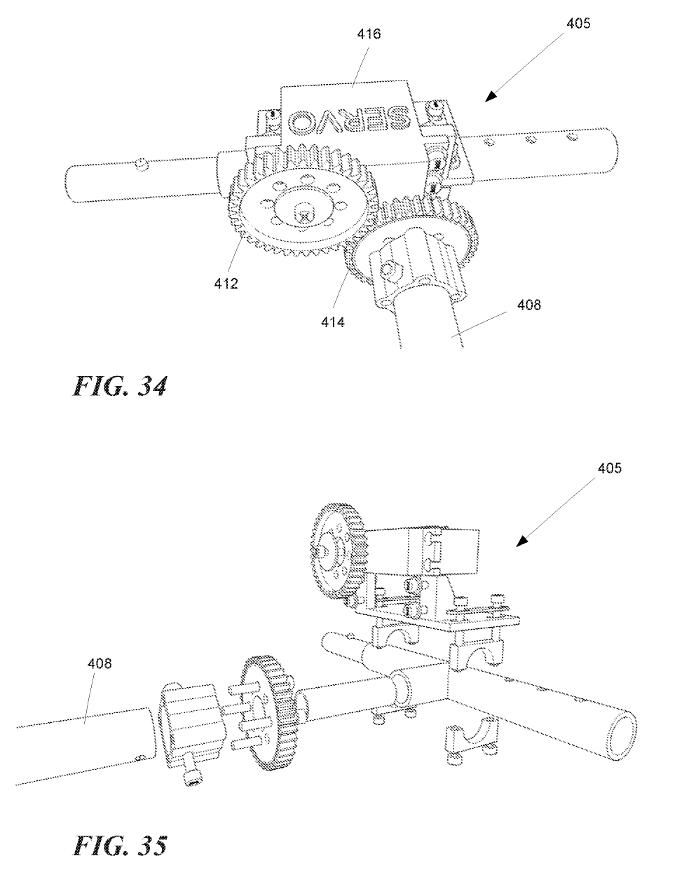

With reference to FIGS. 34 and 35, rotor assembly 306(3) (FIG. 15) is connected to a positioning mechanism 405 for changing the angle of the rotor assembly 306(3). The positioning mechanism 405 rotates the rotor assembly 306(3) between horizontal and vertical orientations to position the rotor assembly 306(3) for VTOL or horizontal propulsion. In some embodiments, the positioning mechanism 405 can rotate the rotor assembly 306(3) approximately 90 degrees. However, in some embodiments, the positioning mechanism 405 can rotate the rotor assembly 306(3) more or less than 90 degrees, and in varying, controllable, increments, thereby providing pitch control, replacing the need for conventional elevator apparatus. The rotor assembly 306(3) is connected to a rotatable shaft 408. A positioning servo 416 rotates the shaft 408 via spur gears 412 and 414. Accordingly, the rotor assembly 306(3) can be positioned as desired by operation of the positioning servo 416. Any number of suitable arrangements and mechanisms capable of rotating the rotor assembly can be used. For example, the positioning mechanism can comprise servo arms, chain drives, and/or the like.

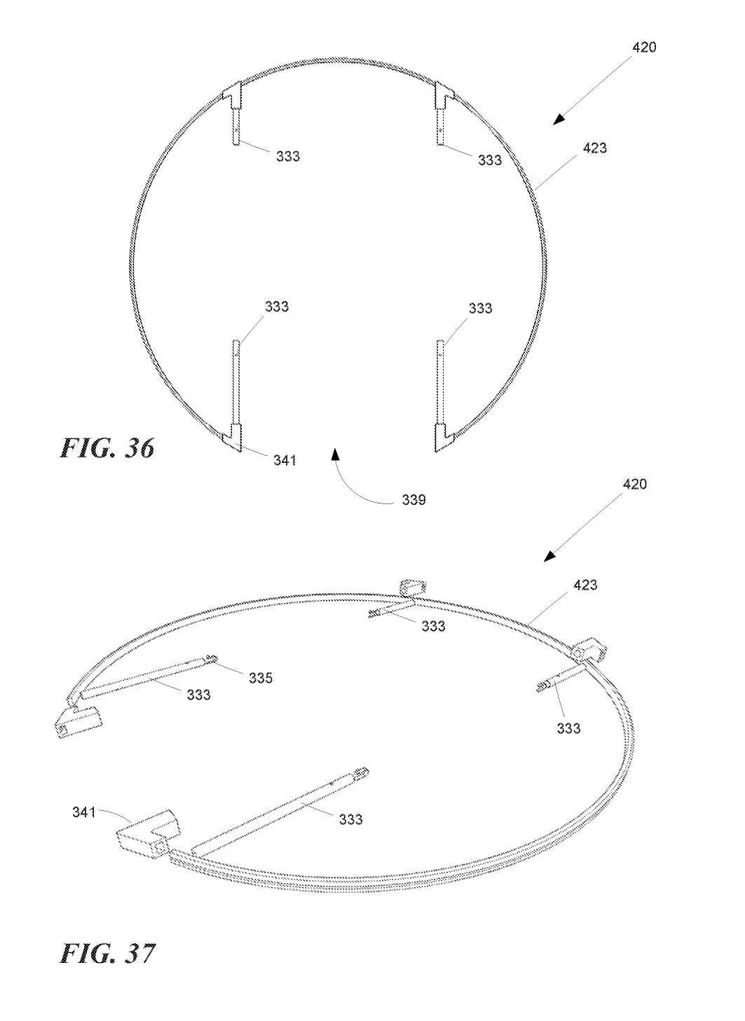

As shown in FIGS. 36 and 37, the propeller guard assembly 420 can be installed and removed quickly and easily without the need for tools. In some embodiments, the propeller guard can be configured to have a forward opening 339 in order to minimize interference with the line of sight of cameras and other sensors that may be in use on the UAV 300 (FIG. 15). The total mass of the propeller guard can be such that the addition of such propeller guard to the UAV 300 does not negate the functionality, usefulness or purpose of the UAV. The propeller guard 420 can be an assembly comprised of a hoop 423 that is sized and shaped to encircle the area occupied by the propellers.

In some embodiments, the hoop 423 can be comprised of fiberglass or other similar material. The hoop 423 can be semicircular in shape, and have a diameter sufficient to encompass or encircle the outermost reaches of the propeller tips with a clearance margin sufficient to prevent contact with the propeller tips. The hoop's edge dimensions can be sized to provide adequate tensile strength while permitting sufficient flexibility to provide resilience and survivability under impact conditions that may be encountered by the UAV, with consideration for the UAV's mass and velocity. In some embodiments, the hoop's edge dimensions can be 12 mm×8 mm, for example.

The hoop 423 is connected to the multi-copter frame 320 (see e.g., FIG. 31) with attachment tubes 333, which have an anterior and a posterior end. The hoop attachment tubes 333 can be comprised of carbon fiber or other rigid, lightweight material, such as aluminum or other composite materials. In a representative embodiment, the hoop attachment tubes 333 are positioned along the hoop 423 in four places, so as to align with the four corresponding ends 331 of the UAV's airframe tubes (FIG. 31). In a representative embodiment, the hoop 423 is open at the forward end, such that the opening 339 is approximately equal in width to the span between the corresponding frame tube end receivers 331 (see e.g., FIG. 31).

With continued reference to FIGS. 36 and 37, in some embodiments, hoop connectors 341 can be used to attach the hoop 423 to the hoop attachment tubes 333. The connectors 341 can be comprised of plastic, carbon fiber, aluminum or other similar sufficiently rigid, lightweight material, and can be shaped or molded, such as with a computer numerical control (CNC) machine or 3D printer, to precisely accommodate the hoop attachment tubes and to match the curvature, shape and dimensions of the hoop. In a representative embodiment, the hoop-to-attachment tube connectors 341 have an anterior end that includes a receptacle sized and shaped to accommodate the posterior end of the hoop attachment tubes 333, and a posterior end shaped to correspond to the size and shape of the hoop's edges. In a representative embodiment, the hoop attachment tube 333 is circular, with an outer diameter of 12 mm. The connector receptacle orifice is shaped likewise, with a diameter of 12.125 mm, and a depth of 30 mm. The posterior end of each hoop attachment tube 333 can be fitted into the corresponding connector receptor orifice and inserted into, and to the full depth of, the orifice. The hoop attachment tube 333 can be secured in place in the connector receptor orifice using glue or other means. The posterior end of each connector 341 can be fitted over the open ends of the hoop and then slid along the hoop to a point that aligns the hoop attachment tube with a corresponding receiver end of the UAV airframe. The connector can be affixed to the hoop with glue or fasteners, for example.

As shown in FIG. 37, in some embodiments, spring button clips 335 can be used to securely attach the airfoil assembly 304 or the propeller guard assembly 420 to the rotorcraft airframe. Returning briefly to FIGS. 31-33, in some embodiments, three holes 337 can be placed in the airframe receivers 331, one at 15 mm inward from the receiver end, then two more, each at 15 mm farther inward than the previous. The spring button clips 335 can be affixed to the attachment tubes 333 of the airfoil assembly and the propeller guard assembly at 15 mm inward from the ends of the attachment tubes. When the attachment tube ends are inserted into the airframe's corresponding receivers, the button of the spring button clip 335 is aligned with a corresponding hole 337, the button penetrates the hole and the spring provides tension to hold it in place, thereby removably locking the assembly to the rotorcraft's airframe. This receiver hole and button spring clip location arrangement results in the attachment tubes of a modular airfoil assembly or propeller guard assembly having a minimum insertion depth of 30 mm, sufficient to provide an adequate structural bond.

This receiver hole and button spring clip location arrangement also offers three positions in which the airfoil assembly or propeller guard can be locked, thereby offering the ability to shift the center of mass of the airfoil assembly or propeller guard assembly to three locations, in increments of 15 mm, relative to the center of gravity of the rotorcraft, permitting the airfoil assembly or propeller guard assembly to be used as a means of adjusting the total center of mass of the UAV and all its components to a point that better coincides with the center of gravity of the rotorcraft serving as the lifting and thrust producing mechanism. Although, various embodiments have been described herein with respect to three holes 337 spaced at 15 mm, more or fewer holes 337 can be used and spaced apart at different distances to provide the desired adjustability. In some embodiments, the spring clips 335 can be replaced or augmented by other fasteners, such as for example and without limitation, pins, linchpins, threaded fasteners, and the like.

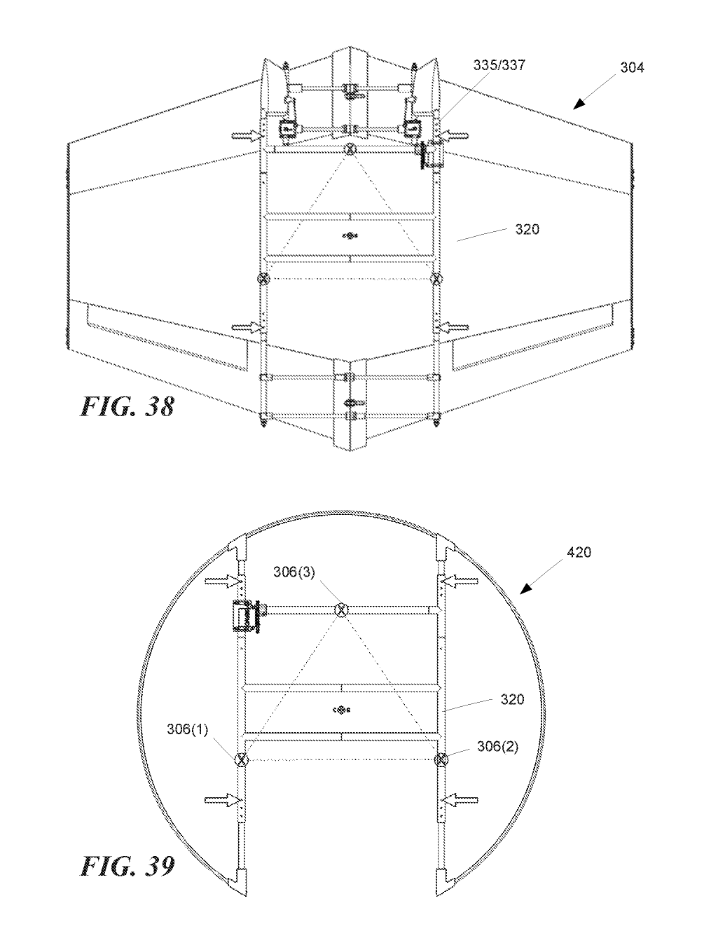

With reference to FIGS. 38 and 39, in a representative embodiment, a closed wing airfoil assembly 304, such as previously described, for example, can be removably attached to a UAV airframe having a thrust and control system, such as the UAV airframe 320 previously described, and locked into position in one or more locations, by way of the spring button clips 335 and respective hole system 337, for example, (see FIG. 38) thus permitting the center of gravity (CG) of the airfoil assembly 304 to be shifted fore and aft relative to the center of gravity of a rotorcraft serving as the lifting and thrust producing mechanism to a position that more nearly coincides with the center of gravity of the rotorcraft, such as to adjust for an off-centered payload, for example. A modular wing airfoil assembly can be installed and removed quickly and easily without the need for tools and the total mass of the modular wing airfoil assembly can be such that the addition of such a modular wing airfoil assembly to the UAV does not negate the functionality, usefulness or purpose of the UAV.

In a representative embodiment, the closed wing airfoil assembly 304 can be removably attached to a rotorcraft having an airframe and thrust and control system, such as the UAV described herein, offering the option of operating the rotorcraft independent of the airfoil assembly such as shown in FIG. 39.

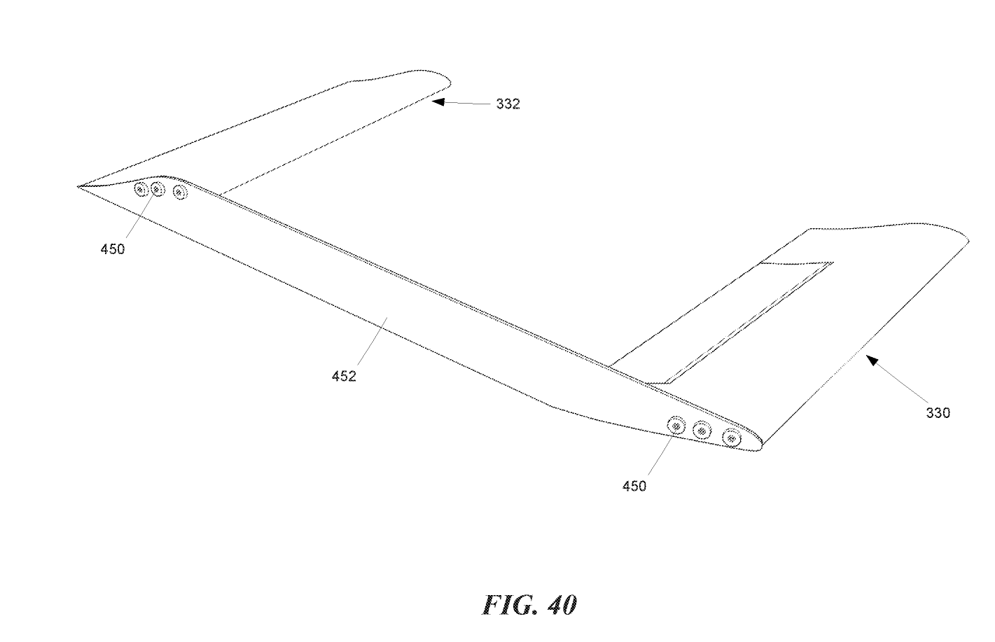

With reference to FIGS. 40-42, in some embodiments, the forewing airfoil assembly 330 can be removably connected to the aft wing airfoil assembly 332 at the respective wingtips, with a wing tip connector, thus forming a removable and adjustable, closed wing airfoil (see e.g., FIG. 24). As shown in FIG. 40, the wing tips can include wingtip receiver holes, sized, shaped and located to accept corresponding attachment mechanisms for the attachment of wingtip connectors. For example, the wing tips can include threaded bores configured to receive suitable fasteners, such as socket head cap screws 450.

A wing tip connector can be any suitable method, means or apparatus that permits connecting the respective wingtips to each other. In a representative embodiment, a wing tip connector can be comprised of a flat connector bar 452. In some embodiments, the connector bar 452 can be comprised of carbon fiber, fiberglass, aluminum or other suitably lightweight, rigid material. In some embodiments, the connector bar 452 can have a thickness of 3 mm, a width of 42 mm and a span of 544 mm, for example. In some embodiments, thumbscrew-type attachment mechanisms can be used to join the wing tip connector to a corresponding wingtip; however, one familiar with the art will understand that any suitable method or means can be used to attach a wing tip connector to a wingtip.

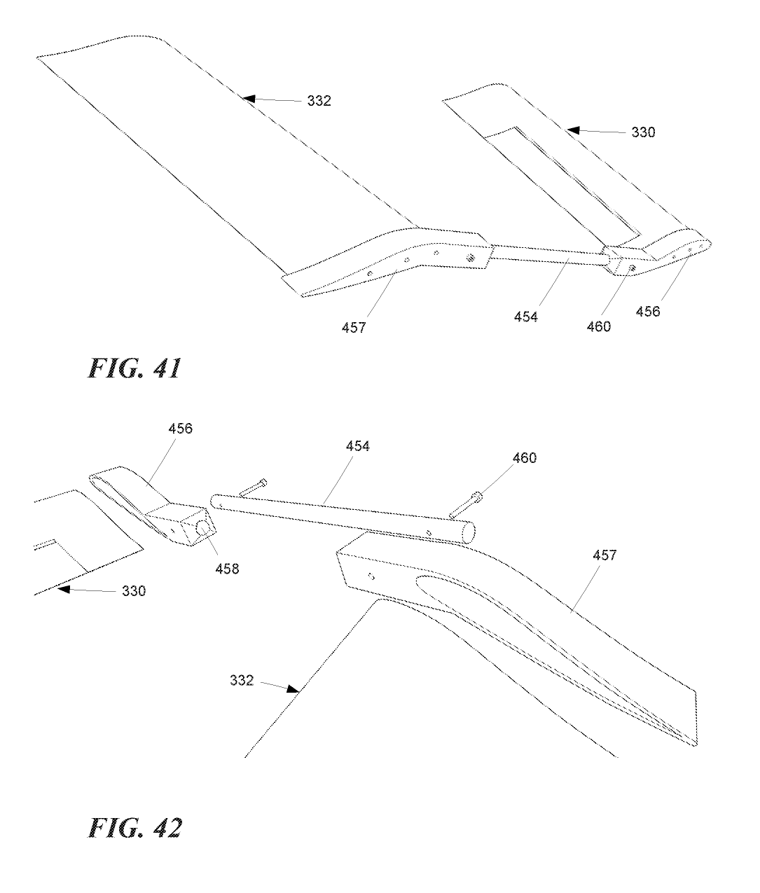

As shown in FIGS. 41 and 42, in an alternative embodiment, a wing tip connector can comprise a removable wingtip connector tube 454 having an anterior and a posterior end, and wingtip receiver boots 456/457, configured to coincide with the shape, size and contour of the corresponding wingtip, and permanently affixed to the corresponding wingtip, which can be affixed to the corresponding wingtip with glue or other means.

In some embodiments, the wingtip receiver boots 456/457 can include a wingtip connector tube orifice 458, such orifice can be sized and shaped to accommodate the wingtip connector tube 454 outer diameter plus a free space margin, to allow the wingtip connector tube to be inserted into the wingtip receiver boot orifice to a depth sufficient to provide a structurally sound connection that minimizes lateral and vertical movement of wingtip connector tube within the wingtip receiver boot orifice. Once the wingtip connector tube 454 is inserted into the orifices 458, it can be secured therein with suitable hardware, such as cap screws or thumbscrew-type attachment mechanisms 460.

A wingtip connector tube can be comprised of carbon fiber, fiberglass, aluminum or other suitably lightweight, rigid material. In some embodiments, the wingtip connector tubes 454 can be 12 mm in diameter. In some embodiments, both the anterior and the posterior ends of the wingtip connector tubes 454 can include a hole located 15 mm inward from the ends. In some embodiments, the wingtip receiver boots 456/457 can be comprised of plastic, carbon fiber, aluminum or other similar sufficiently rigid, lightweight material, and can be shaped or molded, such as with a CNC machine or 3D printer.

On skilled in the relevant art will understand that the lifting force of a wing is dependent on its surface area in combination with forward speed, angle of attack and other factors. At the time of this writing, the U.S. Federal Aviation Administration (FAA) restricts the speed of commercial UAVs to 100 mph. The expected practical use of the UAV of the type addressed in this disclosure is in commercial applications, such as surveying, mapping, inspection, surveillance, law enforcement and civil service operations. The practical, useful speed of an aircraft employed to perform aerial tasks common to such commercial applications is approximately 20 mph to 60 mph. Therefore, it should be appreciated that, in order for a wing to provide sufficient lift to carry its weight along with the weight of the VTOL components plus the weight of a useful load, without increasing the forward horizontal speed of the aircraft to beyond the lawful speed limit set by the FAA and within the range of speeds most expected to be useful for the purposes of the disclosed technology, it can become necessary to increase the wing's surface area.

It should be understood that wing surface area can be increased by either increasing the length (span) of the wing or by increasing the depth (chord) of the wing, or a combination of the two. However, one advantage of the UAVs configured in accordance with the present technology is that they are reasonable in terms of constructability (e.g., maintaining the span and chord of the wing within a range that would be considered reasonable for constructability purposes), and acceptable in terms of marketability. Aircraft with very long or massive wings are less likely to be accepted in the commercial market, due to transportability, packaging and field employment constraints. Thus, using conventional UAV wing designs, results in a wing area incapable of providing lift sufficient to carry the weight of the aircraft plus a useful payload at reduced speeds, as are desirable for performing the tasks for which the present UAV is designed.

One feature of UAVs having configurations in accordance with the embodiments described above is relatively large wing area with a relatively small wingspan when assembled and an even smaller package when disassembled and folded for transport. An advantage of this arrangement is that the UAV has high horizontal flight lift capacity in a lightweight design that allows for increased payload capacity and flight time over conventional hybrid UAV designs. This arrangement provides the further advantage that the UAV can be quickly and easily disassembled and configured for storage within a commercially acceptable envelope, such as the storage area of an SUV, for example. It should be appreciated that the disclosed UAV technology is scalable, both upward and downward. It can be scaled down to a size suitable for a light payload, such as a small camera, in which case it could have a wingspan of about 1½ feet, for example. Or, it can be scaled up to a wingspan of 16 feet, for example, to carry substantial payloads. In one embodiment, the wingspan can be approximately eight feet, which can provide a wing area (and payload capacity) similar to that of a wing having twice the span. The wing surface area (and payload capacity) of the disclosed wing planform is nearly quadrupled by each doubling of the wing span. The closed wing planform typically affords low stall speeds, which allows the UAV to fly at relatively slow speeds more desirable for the applications, such as surveying, mapping, inspection, surveillance, and the like.

In some embodiments, a representative aerial vehicle system can include a vertical takeoff and landing apparatus and a wing assembly removably coupled to the vertical takeoff and landing apparatus. In some embodiments, the vertical takeoff and landing apparatus can include a frame, a control module carried by the frame, and a plurality of thrust assemblies carried by the frame. In some embodiments, at least one of the thrust assemblies can be rotatable between a first position to provide vertical thrust and a second position to provide horizontal thrust. In some embodiments, a positioning mechanism can be coupled to the at least one of the thrust assemblies and operable to rotate the at least one of the thrust assemblies between the first and second positions. In some embodiments, selected ones of the plurality of thrust assemblies each comprise a rotor assembly having a motor and at least one rotor. In some embodiments, a rotor guard is interchangeable with the wing assembly and can be removably coupleable to the vertical takeoff and landing apparatus. In some embodiments, the location of the wing assembly is adjustable fore and aft with respect to the vertical takeoff and landing apparatus. In some embodiments, one or more receptacles are positioned on one of the wing assembly and the vertical takeoff and landing apparatus and one or more mating connectors are positioned on the other of the wing assembly and the vertical takeoff and landing apparatus. In some embodiments, the connectors are attachable to the receptacles and securable thereto at multiple longitudinal positions. In some embodiments, the wing assembly comprises a closed wing structure.

In some embodiments, a representative aerial vehicle system can include a vertical takeoff and landing apparatus, a wing assembly removably coupleable to the vertical takeoff and landing apparatus, and a rotor guard interchangeable with the wing assembly and removably coupleable to the vertical takeoff and landing apparatus. In some embodiments, the vertical takeoff and landing apparatus can include a frame, a control module carried by the frame, and a plurality of thrust assemblies carried by the frame. In some embodiments, at least one of the thrust assemblies is rotatable between a first position to provide vertical thrust and a second position to provide horizontal thrust.

In some embodiments, a representative method for reconfiguring an aerial vehicle can include: positioning a wing assembly on a vertical takeoff and landing apparatus; operating the vertical takeoff and landing apparatus with the wing assembly positioned thereon; removing the wing assembly from the vertical takeoff and landing apparatus; and operating the vertical takeoff and landing apparatus without the wing assembly. In some embodiments, these steps are not necessarily performed in the order recited above. In some embodiments, the method can further comprise moving the wing assembly longitudinally fore and aft of the vertical takeoff and landing apparatus and securing the wing assembly on the vertical takeoff and landing apparatus at a first longitudinal location. In some embodiments, the method can further comprise positioning a rotor guard on the vertical takeoff and landing apparatus and securing the rotor guard thereon at a second longitudinal location. In some embodiments, the vertical takeoff and landing apparatus includes a plurality of thrust assemblies and the method can further comprise rotating at least one of the thrust assemblies between a first position to provide vertical thrust and a second position to provide horizontal thrust.

The above description, drawings, and appendices are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. For example, although the various embodiments are described with respect to unmanned aerial vehicles, the disclosed technology can also be applied to manned vehicles.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. An aerial vehicle system, comprising:
a vertical takeoff and landing apparatus, including:
a frame;
a control module carried by the frame; and
a plurality of thrust assemblies carried by the frame; and
a wing assembly removably coupled to the vertical takeoff and landing apparatus.

2. The aerial vehicle system of claim 1, wherein at least one of the thrust assemblies is rotatable between a first position to provide vertical thrust and a second position to provide horizontal thrust.

3. The aerial vehicle system of claim 2, further comprising a positioning mechanism coupled to the at least one of the thrust assemblies and operable to rotate the at least one of the thrust assemblies between the first and second positions.

4. The aerial vehicle system of claim 1, wherein selected ones of the plurality of thrust assemblies each comprise a rotor assembly having a motor and at least one rotor.

5. The aerial vehicle system of claim 4, further comprising a rotor guard interchangeable with the wing assembly and removably coupleable to the vertical takeoff and landing apparatus.

6. The aerial vehicle system of claim 1, wherein the location of the wing assembly is adjustable fore and aft with respect to the vertical takeoff and landing apparatus.

7. The aerial vehicle system of claim 1, further comprising one or more receptacles positioned on one of the wing assembly and the vertical takeoff and landing apparatus and one or more mating connectors positioned on the other of the wing assembly and the vertical takeoff and landing apparatus.

8. The aerial vehicle system of claim 7, wherein the connectors are attachable to the receptacles and securable thereto at multiple longitudinal positions.

9. The aerial vehicle system of claim 1, wherein the wing assembly comprises a closed wing structure.

10. An aerial vehicle system, comprising:
a vertical takeoff and landing apparatus, including:
a frame;
a control module carried by the frame; and
a plurality of thrust assemblies carried by the frame, wherein at least one of the thrust assemblies is rotatable between a first position to provide vertical thrust and a second position to provide horizontal thrust;
a wing assembly removably coupleable to the vertical takeoff and landing apparatus; and
a rotor guard interchangeable with the wing assembly and removably coupleable to the vertical takeoff and landing apparatus.

11. The aerial vehicle system of claim 10, wherein the wing assembly comprises a closed wing structure.

12. The aerial vehicle system of claim 10, further comprising a positioning mechanism coupled to the at least one of the thrust assemblies and operable to rotate the at least one of the thrust assemblies between the first and second positions.

13. The aerial vehicle system of claim 10, wherein the location of at least one of the wing assembly and the rotor guard is adjustable fore and aft with respect to the vertical takeoff and landing apparatus.

14. The aerial vehicle system of claim 13, further comprising a plurality of receptacles positioned on one of the wing assembly and the vertical takeoff and landing apparatus and a corresponding plurality of mating connectors positioned on the other of the wing assembly and the vertical takeoff and landing apparatus.

15. The aerial vehicle system of claim 14, wherein the connectors are attachable to the receptacles and securable thereto at multiple longitudinal positions.

16. The aerial vehicle system of claim 10, wherein selected ones of the plurality of thrust assemblies each comprise a rotor assembly having a motor and at least one rotor.

17. A method for reconfiguring an aerial vehicle, the method comprising:
positioning a wing assembly on a vertical takeoff and landing apparatus;
operating the vertical takeoff and landing apparatus with the wing assembly positioned thereon;
removing the wing assembly from the vertical takeoff and landing apparatus; and
operating the vertical takeoff and landing apparatus without the wing assembly.

18. The method of claim 17, further comprising moving the wing assembly longitudinally fore and aft of the vertical takeoff and landing apparatus and securing the wing assembly on the vertical takeoff and landing apparatus at a first longitudinal location.

19. The method of claim 17, further comprising positioning a rotor guard on the vertical takeoff and landing apparatus and securing the rotor guard thereon at a second longitudinal location.

20. The method of claim 17, wherein the vertical takeoff and landing apparatus includes a plurality of thrust assemblies, the method further comprising rotating at least one of the thrust assemblies between a first position to provide vertical thrust and a second position to provide horizontal thrust.
